(19) United States
(12) Patent Application Publication
(10) Pub. No.: US 2025/0092852 A1
(43) Pub. Date: Mar. 20, 2025

(54) A GENERATOR AND A METHOD FOR GENERATING ELECTRICITY WITH A GENERATOR

(71) Applicant: ORI SOLUTION OY, Lahti (FI)

(72) Inventors: Jarmo JÄRVINEN, Lahti (FI); Mika MELLER, Lahti (FI); Joakim BERNDTSSON, Lahti (FI); Reijo WALDEN, Lahti (FI)

(21) Appl. No.: 18/576,994

(22) PCT Filed: Jul. 1, 2022
(86) PCT No.: PCT/FI2022/050488

§ 371 Date: Jan. 5, 2024

(30) Foreign Application Priority Data
Jul. 5, 2021 (FI) 20215782

(51) Int. Cl. F03B 17/06; F03D 9/25; H02K 7/18

(52) U.S. Cl. CPC F03B 17/063; F03B 17/067; H02K 7/1823; F03D 9/25; F05B 2210/16; F05B 2220/7066; F05B 2220/7068

(57) ABSTRACT

A generator and a related method are disclosed. The generator includes at least one rotor, at least one bridging element arranged to rotate about a rotation axis (X) of the rotor, an inductance unit holder, the inductance unit holder including at least one inductance unit, the inductance unit including at least one inductance coil, and a core, the at least one bridging element arranged to induce an alternating and pulsed voltage to the at least one inductance coil, the generator including at least one flow channel unit arranged to convey a fluid flow to the rotor. The rotor is arranged to rotate relative to the flow channel unit in a floating bearing manner, with a rotation frequency.

### FIELD OF THE INVENTION

The present invention relates to a generator, and particularly to a generator according to preamble of claim 1. The present invention also relates to a method for generating electricity with a generator, and particularly to a method for generating electricity with a generator according to preamble of claim 21.

### BACKGROUND OF THE INVENTION

A generator is a device for converting mechanical energy into electrical energy. Many generators are based on the electromagnetic Faraday's law of induction which states that a time-varying (that is, changing) magnetic flux generates an electromotive force, that is, voltage, which, in a closed electrical circuit, can be used to generate current and convey electrical energy outside the generator.

In the prior art, the time-varying magnetic flux is usually created by rotating a part of the generator relative to an axis. By subjecting the rotating part to a magnetic flux, the projection of the rotating part changes relative to the magnetic flux, and thus becomes time-varying. By providing a coil to the rotating part, voltage is induced into the coil. Naturally the magnetic flux can also be arranged to rotate relative to a stationary coil or coils. Rotation is only one example of mechanical energy that can cause a time-varying magnetic flux, but it is very advantageous for generators as a rotating machine is usually compact, and electricity generated from a repeated rotation is time-varying, possibly time-harmonic or specifically sinusoidal and thus easily transformed to various voltage levels, as is evident for a person skilled in the art of electrical engineering.

One of the problems associated with the prior art is that to rotate the generator, it must be separately mechanically connected, usually through an axle arrangement, to source of torque that causes the rotation and is the source of the mechanical energy. Sources of torque include a windmill rotor, a turbine or a waterwheel. Mechanical connections like axles suffer from friction that causes losses. Further, as another problem in prior art, in many prior art generators, the generator must rotate in a frequency which is specifically set by the frequency of the power supply the generator is feeding. This calls for very complex gearbox arrangements. Thirdly, it is also very difficult to adapt the structure of the generator to supply electricity in different phases or frequencies. As a fourth challenge in prior art, many electrical generators are based on an alternator construction comprising a rotor and stator, the rotor movement providing the alternating (in general, changing) magnetic flux. Magnets providing the magnetic flux may be either electromagnets or permanent magnets, and the electric coils subjected to the changing magnetic flux density may reside in the stator or in the rotor. As a challenge in prior art, so called brushes and slip rings are needed to feed either magnetisation current into the rotor, or to take produced current out of the rotor. This is problem as brushes and slip rings are mechanical parts subject to wear, thus requiring constant maintenance.

### BRIEF DESCRIPTION OF THE INVENTION

An object of the present invention is to provide a generator to solve or at least alleviate the problems of the prior art.

The objects of the invention are achieved by a generator which is characterized by what is stated in the independent claim 1, and a method for generating electricity with a generator, the method characterized by what is stated in the independent claim 21.

The preferred embodiments of the invention are disclosed in the dependent claims.

As an aspect of the invention, a generator is disclosed. The generator comprises at least one rotor arranged to rotate, at least one bridging element arranged to rotate about a rotation axis of the rotor in response to the rotation of the rotor, and an inductance unit holder. The inductance unit holder comprises at least one inductance unit, and the inductance unit comprises at least one inductance coil, and a core, the at least one bridging element arranged to induce an alternating and pulsed voltage to the at least one inductance coil in response to the rotation of the bridging element relative to the inductance unit. The generator comprises at least one flow channel unit arranged to convey a fluid flow to the rotor for operating the rotor, wherein the rotor is arranged to rotate relative to the flow channel unit in a floating bearing manner and in a rotation frequency. This device has low frictional losses. The device can also be modified very easily to produce various types of alternating pulsed or alternating continuous voltage and electricity by altering the amount and relative location of bridging elements and inductance units.

In an embodiment of the generator, the at least one bridging element is provided to the rotor and the inductance unit holder is arranged to be stationary in the generator. The bridging elements can be directly attached to the rotor, eliminating the need to transfer mechanical rotational power from the rotor to a separate generator.

In an embodiment of the generator, the at least one bridging element is provided to the rotor. The bridging elements can be directly attached to the rotor, eliminating the need to transfer mechanical rotational power from the rotor to a separate generator.

In an embodiment of the generator, the generator comprises at least two bridging elements, and the inductance unit holder comprises at least two inductance units.

In some embodiments, that the rotor comprises an outer circumference or an outer circumference surface. The at least one bridging elements are arranged at the outer circumference of the rotor or in connection with the outer circumference of the rotor. The inductance unit holder comprises an inner surface circumference or an inner circumference surface or in connection with the inner circumference of the inductance unit holder.

The inductance unit holder is arranged to surround the rotor in radial direction of the rotor. The inner surface circumference of the inductance unit holder is arranged to surround the outer circumference of the rotor. Thus, the bridging elements are arranged to pass the inductance units during rotation of the rotor.

In an embodiment of the generator, the rotor comprises an outer circumference. At least two bridging elements are arranged at the outer circumference of the rotor, the at least two bridging elements being separated with a first angular interval. At least two inductance units are arranged in the inductance unit holder, the at least two inductance units being separated with a second angular interval. This enables various time behaviours of electricity (voltage) to be produced.

In an embodiment of the generator, the rotor comprises a first end plate, the first end plate forming a first end of the rotor, and at least two bridging elements are arranged at the first end plate of the rotor, the bridging elements being separated with a first angular interval. At least two inductance units are arranged in the inductance unit holder, the at least two inductance units being separated with a second angular interval. Placing the bridging elements at the first end plate of the rotor is advantageous as the first end plate is at least partially a plate or plate-like structure that easily accommodate the bridging elements.

In an embodiment, the bridging elements are separated with a first angular interval, and the inductance units are separated with a second angular interval.

In an embodiment of the generator, the rotor comprises a second end plate, the second end plate forming a second end of the rotor, and at least two bridging elements are arranged at the second end plate of the rotor, the bridging elements being separated with a first angular interval, and at least two inductance units are arranged in the inductance unit holder, the at least two inductance units being separated with a second angular interval. Placing the bridging elements at the second end plate of the rotor is advantageous as the second end plate of the rotor is a plate or plate-like structure that easily accommodates the bridging elements.

In an embodiment of the generator, each of the bridging elements has a bridging angular length, each of the bridging elements is separated from the adjacent bridging element by a bridging angular separation, each of the inductance units has an inductance unit angular length, each of the inductance units is separated from the adjacent inductance unit by an inductance unit angular separation, such that the bridging angular length is between 70% and 130% of the bridging angular separation, the inductance unit angular separation is between 70% and 130% of the bridging angular separation, and the bridging angular length is between 70% and 130% of the inductance unit angular length, whereby the alternating and pulsed voltages of each of the inductance coils merge to alternating and continuous voltages for each of the inductance coils of the inductance units, the alternating and continuous voltages having a frequency which is a number of bridging elements multiplied by the rotation frequency of the rotor. This arrangement is advantageous as it produces, for example, a sinusoidal or a sinusoidal-like waveform as voltage of each of the inductance coils.

In an embodiment of the generator, the rotor comprises a predetermined number of bridging elements and the inductance unit holder comprises a predetermined number of inductance units such that the predetermined number of bridging elements is equal to the predetermined number of inductance units, whereby the alternating and pulsed voltages of all the inductance coils of the inductance units have a same phase and have a pulse frequency, the pulse frequency being the predetermined number of bridging elements multiplied by the rotation frequency of the rotor. This arrangement is advantageous for a single-phase output.

In an embodiment of the generator, the rotor comprises a predetermined number of bridging elements and the inductance unit holder comprises a predetermined number of inductance units such that the predetermined number of bridging elements is not equal to the predetermined number of inductance units, whereby the alternating and pulsed voltages of the inductance coils of each of the inductance units have at least two different phases, and have a same pulse frequency. The pulse frequency is the predetermined number of bridging elements multiplied by the rotation frequency of the rotor. This arrangement produces a multi-phase output which is advantageous as it lessens the force or torque needed to start up the rotor to rotate.

In an embodiment of the generator, the rotor comprises a predetermined number of bridging elements and the inductance unit holder comprises a predetermined number of inductance units such that the predetermined number of bridging elements is one more than the predetermined number of inductance units, whereby the alternating and pulsed voltages of the inductance coils of each of the inductance units have a number of phases which equals to the predetermined number of inductance units, and a pulse frequency which is the predetermined number of bridging elements multiplied by the rotation frequency of the rotor. This embodiment produces a high number of different phases which is very advantageous to considerably lessen the force or torque needed to start up the rotor to rotate.

In an embodiment of the generator, the rotor comprises a predetermined number of bridging elements and the inductance unit holder comprises a predetermined number of inductance units such that the predetermined number of bridging elements is one more than the predetermined number of inductance units, whereby the alternating and pulsed voltages of the inductance coils of each of the inductance units have a pulse frequency which is the predetermined number of bridging elements multiplied by the rotation frequency of the rotor. This embodiment produces a high number of different phases which is very advantageous to considerably lessen the force or torque needed to start up the rotor to rotate.

In an embodiment of the generator, the rotor comprises a predetermined number of bridging elements and the inductance unit holder comprises a predetermined number of inductance units such that he predetermined number of bridging elements is one less than the predetermined number of inductance units, whereby the alternating and pulsed voltages of the inductance coils of each of the inductance units have a number of phases which equals to the predetermined number of inductance units, and a pulse frequency which is the predetermined number of bridging elements multiplied by the rotation frequency of the rotor. This embodiment produces a high number of different phases which is very advantageous to considerably lessen the force or torque needed to start up the rotor to rotate.

In an embodiment of the generator, the rotor comprises a predetermined number of bridging elements and the inductance unit holder comprises a predetermined number of inductance units such that he predetermined number of bridging elements is one less than the predetermined number of inductance units, whereby the alternating and pulsed voltages of the inductance coils of each of the inductance units have a pulse frequency which is the predetermined number of bridging elements multiplied by the rotation frequency of the rotor. This embodiment produces a high number of different phases which is very advantageous to considerably lessen the force or torque needed to start up the rotor to rotate.

In an embodiment of the generator, as the at least one bridging element is arranged to rotate about a rotation axis, the at least one bridging element is arranged into a rotational movement that causes the at least one bridging element to arrange a magnetic circuit to alternate between an open state, in which the magnetic circuit is formed of the inductance unit and of at least one substance which at least partially surrounds the inductance unit, and a closed state, in which the magnetic circuit is formed of the bridging element, of the inductance unit and of the at least one substance which at least partially surrounds the inductance unit, such that a voltage is induced to the inductance coil of the inductance unit. This arrangement enables a compact design to produce alternating magnetic flux for electromagnetic induction to generate alternating voltages.

In an embodiment of the generator, the at least one substance which at least partially surrounds the inductance unit comprises the fluid of the fluid flow operating the rotor. Thus, it is possible to convey the fluid operating the rotor, and the generator in general, very close to the electricity inducing units. This makes sealing of the generator considerably easier as the fluid of the fluid flow can even become part of the magnetic circuit of the electricity generation.

The number of bridging elements is the predetermined number of bridging elements.

In an embodiment of the generator, the core of the inductance unit comprises ferromagnetic material, and the core of the inductance unit: comprises a permanent magnet portion; or comprises an electromagnet; or is a permanent magnet. These are advantageous ways to generate magnetic flux.

In an embodiment of the generator, the bridging element: comprises a permanent magnet; or comprises an electromagnet; or comprises ferromagnetic material. These are advantageous ways to generate magnetic flux.

In an embodiment of the generator, in the open state the bridging element is unmagnetized. Remarkably, the bridging element can be a simple ferromagnetic, unmagnetized material, e.g. a strip of iron or ferrite, and still the generator produces electricity.

In an embodiment of the generator, the generator comprises at least one rectifier, the at least one rectifier comprising alternating voltage input nodes and rectified voltage output nodes. The inductance unit comprises: one inductance coil connected to the alternating voltage input nodes of the rectifier; or a first inductance coil and a second inductance coil, the first inductance coil connected to the alternating voltage input nodes of a first rectifier, and the second inductance coil connected to the alternating voltage input nodes of a second rectifier; or a first inductance coil and a second inductance coil arranged in a series connection, the series connection connected to the alternating voltage input nodes of the at least one rectifier; or a first inductance coil and a second inductance coil arranged in a parallel connection, the parallel connection connected to the alternating voltage input nodes of the at least one rectifier. These are advantageous arrangements for taking the electricity out of the inductance coil.

In an embodiment of the generator, the generator comprises: at least one electrical energy storage unit connected to the rectified voltage output nodes of the at least one rectifier; or at least one electrical energy storage unit connected to the rectified voltage output nodes of the at least one rectifier, and at least one inverter arranged to convert rectified voltage of the at least one electrical energy storage unit to an alternating output voltage. These are advantageous arrangements for connecting the generator to an external electricity network, or to supply various loads with electricity.

In an embodiment of the generator, the flow channel unit and the rotor have a common axial direction and that the flow channel unit and the rotor are arranged in the axial direction (X) substantially successively to each other. This arrangement makes a reliable construction and feeding of the driving fluid flow into the rotor straightforward.

In an embodiment of the generator, the rotor is arranged to rest on the flow channel unit when the generator is not in use, and to float relative to the flow channel unit when the generator is in operation. Thus, advantageously, both operational and non-operational states are covered with this arrangement. The floating rotor arranges also a low-friction construction when in the generator is in operation and the rotor rotates.

Thus, the floating bearing means that the rotor floats relative to the flow channel unit when the generator is in operation.

In other words, the floating bearing means that the rotor floats relative to the flow channel unit when the rotor operates.

In still other words, the floating bearing means that the rotor floats relative to the flow channel unit when the rotor rotates.

In an embodiment of the generator, the flow channel unit comprises at least one channel for conveying at least one fluid flow between the flow channel unit and the rotor to create a pressure effect between the flow channel unit and the rotor to push, in the axial direction of the flow channel unit and the rotor, the rotor away from the flow channel unit such that a gap is arranged between the flow channel unit and the rotor for allowing the rotor to rotate relative to the flow channel unit substantially friction-free. The flow channel unit comprises at least one channel for conveying at least one fluid flow to the rotor for rotating the rotor. This is an advantageous way to arrange the floating bearing arrangement of the generator. In other words, this is an advantageous way to arrange the floating bearing.

For the purposes of this text, “to rotate in a floating bearing manner” means that the rotor floats relative to the flow channel unit when the generator is in operation.

The float may be arranged, for example, by the at least one fluid flow between the flow channel unit and the rotor.

In an embodiment of the generator, the rotor is arranged to at least partly surround the flow channel unit. This enables to drive the flow of fluid from the centre towards the edges of the rotor, which is advantageous mechanically and in terms of efficiency. This is also advantageous, as the flow of fluid that causes the rotor to rotate can be routed from the centre of the rotor towards the edges, providing an advantageous turbine-like arrangement.

In an embodiment of the generator, the at least one channel conveying at least one fluid flow to the rotor for rotating the rotor is arranged to extend in the flow channel unit in at least partly radial direction (R) such that an outlet opening of the channel is arranged at an outer periphery of the flow channel unit at the position of the rotor in an axial direction (X) of the flow channel unit. This allows to turn the fluid flow at least partially to the radial direction which helps in controlling the pressure effect that pushes the rotor away from the flow channel unit. This also enables further to drive the flow of fluid from the centre towards the edges of the rotor, which is advantageous mechanically and in terms of efficiency.

In an embodiment of the generator, the at least one rotor comprises a number of rotor flow channels extending in at least partly radial direction (R) of the rotor, the fluid flow flowing through the rotor flow channels for rotating the rotor. Radial direction is advantageous as it does not create forces in axial (X) direction. This also enables to drive the flow of fluid from the centre towards the edges of the rotor, which is advantageous mechanically and in terms of efficiency.

In an embodiment of the generator, at least one inductance unit is arranged to be repeatedly brought to an area of an influence of the moving bridging element, and arranged to be repeatedly removed from an area of an influence of the moving bridging element.

In an embodiment of the generator, at least one inductance unit is arranged at an area of an influence of the moving bridging element.

In an embodiment of the generator, the at least one bridging element is arranged at the rotor. Arranging the bridging element directly into the rotor without any power transmission means in between is yields a reliable, yet feasible construction.

In an embodiment of the generator, the inductance unit is stationary in the generator.

In an embodiment of the generator, the flow channel unit comprises at least one first inlet flow channel and at least one second inlet flow channel, the at least one first inlet flow channel being arranged to convey a fluid flow to the at least one channel conveying at least one fluid flow to create the pressure effect between the flow channel unit and the rotor and the at least one second inlet flow channel being arranged to convey a fluid flow to the at least one channel conveying at least one fluid flow to the rotor for rotating the rotor. Separate channels for the pressure effect and rotation are advantageous for adjusting accurately the flows of fluid.

In an embodiment of the generator, the flow channel unit comprises, in the axial direction (X) thereof, a first end and a second end. The rotor comprises, in the axial direction (X) thereof, a first end facing towards the flow channel unit and a second end facing away from the flow channel unit. At the first end of the rotor there is an opening arranged to receive the second end of the flow channel unit so as to arrange the rotor to partly surround the flow channel unit at the second end of the flow channel unit in the axial direction of the flow channel unit and the rotor.

In an embodiment of the generator, the flow channel unit comprises a chamber being open towards the rotor and the rotor comprises, at the opening, an extension extending from the second end of the rotor towards the opening, the chamber in the flow channel unit arranged to at least partly accommodate the extension in the rotor when the extension is inserted into the chamber.

In an embodiment of the generator, the chamber in the flow channel unit comprises a first end and a second end, and the extension in the rotor comprises a first end and a second end. The first end of the chamber and the first end of the extension are arranged to face to each other when the extension is inserted into the chamber. The at least one channel conveying at least one fluid flow to create the pressure effect between the flow channel unit and the rotor is arranged to convey the at least one fluid flow portion between the first end of the chamber and the first end of the extension through at least one outlet opening of the at least one channel arranged at the first end of the chamber.

In an embodiment of the generator, the fluid flow is a flow of at least one of air, steam, exhaust gas and liquid. Thus, the generator is operable through a variety of fluid flows, and thus easily arranged to harvest energy from various fluid flows.

In an embodiment of the generator, the fluid is in gaseous, supercritical or heterogeneous fluid phase. The generator is also operable through a variety of flowing fluid phases, and thus easily arranged to harvest energy from various fluid flows.

For the purposes of this text, a “fluid phase” means a chemical or physical form of matter (e.g. a gas phase or a liquid phase).

For the purposes of this text, a “phase” means the time offset between two substantially same or similar time-dependent voltages. In other words, the phase is defined as the position of the waveform or a pulse form at a fraction of time period. Phase may be expressed in units of time. In other words, phase can is an expression of relative displacement between two corresponding features (for example, peaks or zero crossings or DC crossings) of two waveforms, pulse forms or alternating pulses having the same or substantially same frequency.

The invention is based on the idea of providing a rotor, at least one bridging element arranged to rotate about a rotation axis (X) of the rotor in response to the rotation of the rotor, and at least one inductance unit. The inductance unit comprises at least one inductance coil and a core. The core is brought repeatedly into an area of an influence of the at least one bridging element, and removed repeatedly from the area of an influence of the at least one bridging element, the at least one bridging element arranged to induce an alternating and pulsed voltage to the at least one inductance coil in response to the rotation of the bridging element relative to the inductance unit. The generator also comprises at least one flow channel unit for conveying a fluid flow to the rotor for operating the rotor, wherein the rotor is arranged to rotate relative to the flow channel unit in a floating bearing manner.

As another aspect of the present invention, a method for generating electricity with a generator is disclosed. The generator comprises at least one flow channel unit, at least one rotor arranged to rotate, at least one bridging element, an inductance unit holder, the inductance unit holder comprising at least one inductance unit, the inductance unit comprising at least one inductance coil and a core. The method comprises steps of:
conveying, with at least one flow channel unit, a fluid flow to the rotor for operating the rotor,
rotating the rotor relative to the flow channel unit in a floating bearing manner and in a rotation frequency,
rotating the at least one bridging element about a rotation axis of the rotor in response to the rotation of the rotor, and
inducing, with the at least one bridging element, an alternating and pulsed voltage to the at least one inductance coil in response to the rotation of the at least one bridging element relative to the inductance unit. The method enables a device that has low frictional losses. The device can be modified to produce various types of alternating pulsed or alternating continuous voltage and electricity.

In an embodiment of the method, the at least one inductance unit is arranged at an area of an influence of the at least one bridging element.

In an embodiment of the method, the method comprises steps of:
alternating, through the rotation of the at least one bridging element about the rotation axis, a magnetic circuit between an open state, in which the magnetic circuit is formed of the inductance unit and of at least one substance which at least partially surrounds the inductance unit, and a closed state in which the magnetic circuit is formed of the bridging element, of the inductance unit and of the at least one substance which at least partially surrounds the inductance unit, and
inducing, through the alternating step, a voltage to the at least one inductance coil of the at least one inductance unit. These method steps enable a compact design to produce alternating magnetic flux for electromagnetic induction.

In an embodiment of the method, the method is executed in a generator as defined above in the generator aspect and its embodiments.

An advantage of the invention is that the rotation of the rotor may directly (or with a minimal number of interconnecting mechanical parts) rotate the bridging elements and thus energy is wasted e.g. in friction minimally. An alternating and pulsed voltage induced to the inductance coils is a more general time-varying form of voltage than a typical sinusoidal waveform, but still equally applicable for energy generation especially if the alternating and pulsed voltage is rectified to a direct current (DC), or generally, to electricity having a non-zero DC component.

For the purposes of this text, a “generator” is a generator for electricity generation through electromagnetic induction, specifically, through Faraday's law of induction.

For the purposes of this text, a “ferromagnetic material” means a material which exhibits a spontaneous net magnetization at the atomic level, even in the absence of an external magnetic field. When placed in an external magnetic field, ferromagnetic materials are strongly magnetized in the direction of the field. Examples of ferromagnetic materials are iron, steel, ferrites and many alloys like alnico, and some rare earth metal alloys like neodymium magnets and samarium-cobalt magnets.

For the purposes of this text, an “angular interval” means an angle spanned by an interval of two adjacent objects arranged substantially circumferentially relative to the observation point and determined from the same location of the two objects, e.g. from two same sides of two objects, or two center lines of two objects, said center lines extending radially and perpendicularly to the direction of the interval spanned by the angle.

### BRIEF DESCRIPTION OF THE DRAWINGS

The invention is described in detail by means of specific embodiments with reference to the enclosed drawings, in which

FIG. 1 shows a schematic side view of a generator according to an embodiment of the invention,

FIGS. 2-5 show schematic views of generators according to various embodiments of the invention, mostly in the direction of axis of rotation, FIG. 2 also showing the axial, radial and circumferential directions used throughout for the purposes of this text,

FIGS. 6a and 6b show, as embodiments, schematic views of magnetic circuits in closed (FIG. 6a) and open (FIG. 6b) states,

FIGS. 7a-7c show embodiments of inductance units,

FIGS. 8a-8c show embodiments of bridging elements,

FIGS. 9a-9d show embodiments related to connections of inductance coils,

FIG. 10 shows an exemplary electricity output arrangement,

FIG. 11 shows a schematic, exemplary view from the second end of the generator,

FIG. 12 shows a schematic side view of a generator according to an embodiment of the invention,

FIG. 13 shows a schematic view of a rotor according to an embodiment of the invention in the direction of the axis of rotation,

FIG. 14 shows a schematic projection view of a generator, in particular the rotor, according to an embodiment of the invention,

FIG. 15 shows a cutting plane view of a rotor according to an embodiment of the invention,

FIGS. 16-19 show details of flow channel units according to embodiments of the invention, and

FIGS. 20-21 illustrate a method aspect and its embodiments according to the invention.

### DETAILED DESCRIPTION OF THE INVENTION

In the present text and figures, like labels and like numbers denote like elements in the figures.

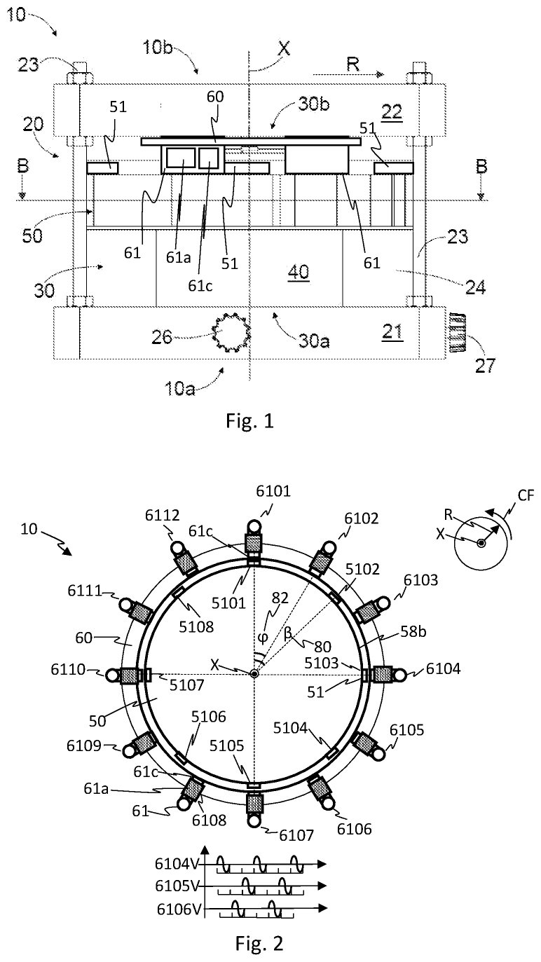

As an aspect of the present invention, FIG. 1 illustrates a generator 10. The generator 10 comprises at least one rotor 50 arranged to rotate, and at least one bridging element 51 arranged to rotate about a rotation axis X of the rotor 50 in response to the rotation of the rotor 50. The generator 10 also comprises an inductance unit holder 60. The inductance unit holder 60 comprises at least one inductance unit 61. The inductance unit 61 comprises at least one inductance coil 61a and a core 61c. The at least one bridging element 51 is arranged to induce an alternating and pulsed voltage to the at least one inductance coil 61a in response to the rotation of the bridging element 51 relative to the inductance unit 61. The generator 10 comprises at least one flow channel unit 40 arranged to convey a fluid flow to the rotor 50 for operating the rotor 50, wherein the rotor 50 is arranged to rotate relative to the flow channel unit 40 in a floating bearing manner and in a rotation frequency 88.

The inductance coil 61a may be coiled around the core 61c of the inductance unit 61. There may be a predetermined number of turns in the inductance coil 61a around the core 61c.

FIG. 2 illustrates, through time behaviour of voltages 6104V, 6105V and 6106V, the concept of the alternating and pulsed voltages. Alternating and pulsed voltages are illustrated with waveforms 6104V, 6105V and 6106V that illustrate the voltages of the inductance coils 61a of inductance units 6014-6106, respectively.

As a rotating system is advantageously defined at least in part by a cylindrical coordinate system, FIG. 2 also defines the radial (R), axial (X) and circumferential (CF), that is, azimuth directions or dimensions used throughout in this text.

Axial dimension X is the dimension perpendicular to radial and circumferential dimensions.

In other words, axial dimension X is the dimension pointing directly outwards from the plane of FIG. 2.

An alternating voltage is a voltage that has voltages of alternating polarities. In other words, an alternating voltage is a voltage that alternates around a DC voltage.

The DC voltage may be a zero voltage.

For the purposes of this text, an “alternating and pulsed voltage” means a voltage that alternates around a DC voltage at least once for an active period of time, and stays at a DC voltage for a passive period of time such the passive period of time follows or precedes the active period of time, as shown in the time behaviours of voltages 6104V, 6105V and 6106V of FIG. 2.

In FIG. 2, for voltages 6104V, 6105V and 6106V, there is an active period of an alternating pulse, which is, as in this example, a sinusoidal pulse with a positive polarity half cycle, and a negative polarity half cycle. However, the active period can comprise any other alternating pulse form, for example, a positive half cycle of a trapezoidal pulse, and a negative half cycle of a trapezoidal pulse. The active period is followed by a passive period during which the voltage stays essentially zero, or, generally, at a steady DC component.

The steady DC component may be a zero voltage.

The passive period lasts approximately two times the duration of the active period in the example of FIG. 2.

One active period of time and one passive period of time form a pulse cycle.

Pulse cycles occur repeatedly in time when the generator 10 operates.

Duration of one pulse cycle Tp has an inverse fp, which is the pulse frequency, fp=1/Tp.

The DC voltage may be a zero voltage, or the time-average of the alternating and pulsed voltage, or an offset voltage, or a voltage of some ground potential.

The alternating voltage may comprise a period of sinusoidal waveform.

The alternating voltage may comprise a period of a time-harmonic waveform.

In other words, an alternating and pulsed voltage is a voltage that reaches both polarities relative to a DC voltage for the active period of time, and stays substantially at the DC voltage during the passive period of time.

In an embodiment, and as further illustrated in FIG. 1 and in FIG. 2-FIG. 5, related to the generator 10, the at least one bridging element 51 is provided to the rotor 50, and the inductance unit holder 60 is arranged to be stationary in the generator 10.

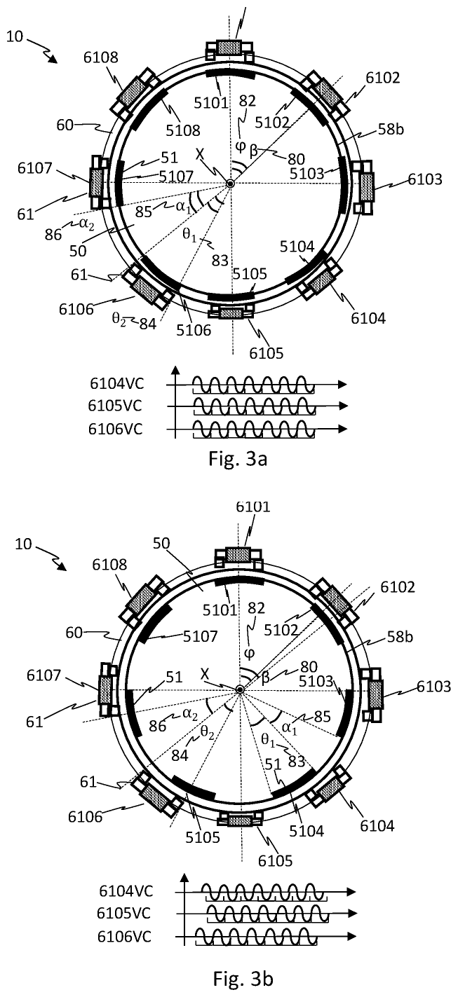

In an embodiment related to the generator 10, and as further illustrated in FIG. 2-FIG. 3b, the rotor 50 comprises an outer circumference 58b. At least two bridging elements 51 are arranged at the outer circumference 58b of the rotor 50. The at least two bridging elements 51 are separated with a first angular interval 80. At least two inductance units 61 are arranged in the inductance unit holder 60, the at least two inductance units 61 being separated with a second angular interval 82.

In an embodiment, and as shown in FIG. 2, the at least one bridging element 51 and the at least one inductance unit 61 are aligned in the axial direction X.

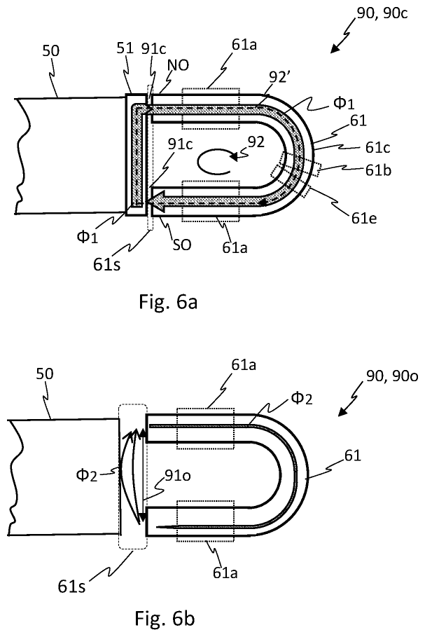

In the embodiment, and referring also to FIG. 6a, one bridging element 51 and one inductance unit 61 may form a magnetic circuit 90. The magnetic circuit 90 is in a closed state 90c when there is any overlap, in a plane spanned by the circumferential dimension CF and the axial dimension X, between said one inductance unit 61 and said one bridging element 51.

Similarly, and referring also to FIG. 6b, the magnetic circuit 90 is in an open state 90o when there is no overlap, in a plane spanned by the circumferential dimension CF and the axial dimension X, between said one inductance unit 61 and said one bridging element 51.

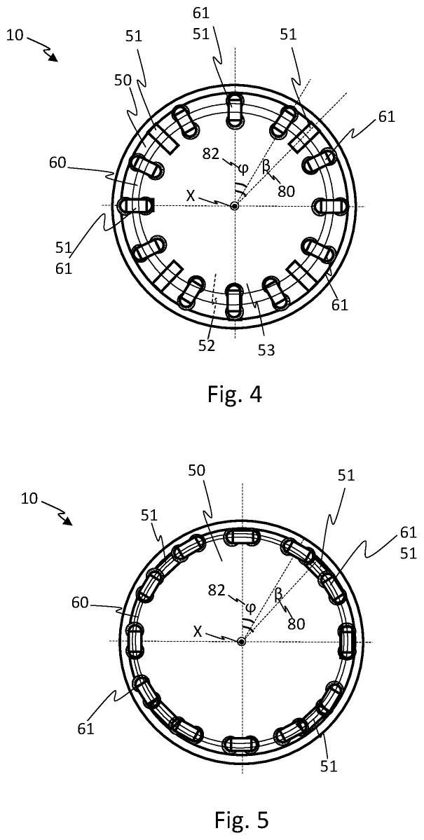

In an embodiment related to the generator 10, and for illustration, turning to FIG. 4 and FIG. 15, the rotor 50 comprises a first end plate 52 (in FIG. 4, label 52 points behind the projected figure), the first end plate 52 forming a first end 50a of the rotor, and at least two bridging elements 51 are arranged at the first end plate 52 of the rotor 50. The bridging elements 51 are separated with a first angular interval 80 (angle β), and at least two inductance units 61 are arranged in the inductance unit holder 60. The at least two inductance units are separated with a second angular interval 82 (angle q).

As shown e.g. in FIG. 2, the first angular interval 80 is constant over the whole circumference of the rotor 50 for the bridging elements 51.

In other words, for the purposes of this text, the first angular interval 80 is a predetermined first angular interval 80.

Thus, the first angular interval 80 is the same for all bridging elements 51.

As shown in FIG. 2, the second angular interval 82 is constant over the whole circumference of the inductance unit holder 60 for the inductance units 61.

In other words, for the purposes of this text, the second angular interval 82 is a predetermined second angular interval 82.

Thus, the second angular interval 82 is the same for all inductance units 61.

In an embodiment, and as shown in FIG. 4, the at least one bridging element 51 and the at least one inductance unit 61 are aligned in the radial direction R.

As defined above, an “angular interval”, for the purposes of this text, means an angle the interval of two adjacent objects span, relative to an observation point where the said angle is determined, and determined from the same location of the two objects, e.g. from two same sides of two objects, or two center lines of two objects, said center lines extending radially and perpendicularly to the direction of the interval spanned by the angle.

In FIG. 4, the first angular interval 80 is determined from the radial center lines of two adjacent bridging elements 51.

In FIG. 4, the second angular interval 82 is determined from the radial center lines of two adjacent inductance units 61.

Thus, the first angular interval 80 is a first angle of the interval spanned by two adjacent bridging elements 51, the first angle being determined from the rotation axis X. The rotation axis is X the centre of rotation.

Thus, the second angular interval is a second angle of the interval spanned by two adjacent inductance units 61, the second angle being determined from the rotation axis X. The rotation axis is X the centre of rotation.

In an embodiment related to the generator 10, and for illustration, turning to FIG. 4 and FIG. 15, the rotor 50 comprises a second end plate 53, the second end plate 53 forming a second end 50b of the rotor. At least two bridging elements 51 are arranged at the second end plate 53 of the rotor 50. The bridging elements 51 are separated with a first angular interval 80. At least two inductance units 61 are arranged in the inductance unit holder 60, and the at least two inductance units 61 are separated with a second angular interval 82.

The first end 50a and the second end 50b are at the opposite ends of the rotor 50.

In an embodiment, and as shown in FIG. 5, the at least one bridging element 51 and the at least one inductance unit 61 are aligned in the circumferential direction CF.

In the embodiment, one bridging element 51 and one inductance unit 61 may form a magnetic circuit 90. The magnetic circuit 90 is in a closed state 90c when there is any overlap, in a plane spanned by the circumferential dimension CF and the radial dimension R, between said one inductance unit 61 and said one bridging element 51. Similarly, the magnetic circuit 90 is in an open state 90o when there is no overlap, in a plane spanned by the circumferential dimension CF and the radial dimension R, between said one inductance unit 61 and said one bridging element 51. For the magnetic circuit 90 and its states 90c and 90o, FIGS. 6a and 6b are referred to.

In an embodiment related to the generator 10, and for illustration, referring to FIGS. 3a and 3b, each of the bridging elements 51 has a bridging angular length 83 (angle θ1), and each of the bridging elements 51 is separated from the adjacent bridging element by a bridging angular separation 85 (angle α1). Further, each of the inductance units 61 has an inductance unit angular length 84, (angle θ2), and each of the inductance units 61 is separated from the adjacent inductance unit 61 by an inductance unit angular separation 86 (angle α2). To achieve an alternating and continuous time behaviour of the voltages of the inductance coils 61a, the bridging angular length 83 is between 70% and 130% of the bridging angular separation 85, the inductance unit angular separation 86 is between 70% and 130% of the bridging angular separation 85, and the bridging angular length 83 is between 70% and 130% of the inductance unit angular length 84. With this arrangement of the inductance units and bridging elements, the alternating and pulsed voltages of each of the inductance coils 61a merge to alternating and continuous voltages for each of the inductance coils 61a of the inductance units 61. The alternating and continuous voltages have a frequency which is a number of bridging elements multiplied by the rotation frequency 88 of the rotor 50.

The alternating and continuous voltages may have a frequency which is a predetermined number of bridging elements multiplied by the rotation frequency 88 of the rotor 50.

For the purposes of this text, the rotation frequency f, 88 of the rotor is the inverse of time T it takes for the rotor 50 to complete one revolution around its rotation axis X such that f=1/T.

The rotation frequency 88 may depend, for example, on the fluid flow, on the rate of fluid flow, on the pressure of fluid flow, or on the density of the fluid in the fluid flow, or on any combination thereof.

For the purposes of this text, an “alternating and continuous voltage” means a voltage that alternates around a DC (“direct current”, that is, average voltage level of the alternating and continuous voltage) component and changes constantly or substantially constantly.

The DC voltage level may be a zero voltage.

The alternating and continuous voltage may be a voltage that alternates sinusoidally over time.

Each alternation of the alternating and continuous voltage may comprise an alternating cycle, one alternating cycle lasting an alternating cycle time.

Each alternating cycle may comprise two alternating half cycles, a first alternating half cycle and a second alternating half cycle.

During the first alternating half cycle, the polarity of the voltage is opposite to the voltage during the second alternating half cycle, the polarity determined relative to the DC voltage of the alternating and continuous voltage.

The duration of the first alternating half cycle may be the same as the duration of the second alternating half cycle.

The duration of the first alternating half cycle may be substantially the same as the duration of the second alternating half cycle.

The alternating and continuous voltage may comprise one or more periods of unchanging voltage, the period of unchanging voltage lasting maximally a time of 10% of the alternating cycle time.

The alternating and continuous voltage may comprise a series of alternating and pulsed voltages.

In other words, a series of alternating and pulsed voltages may merge to the alternating and continuous voltage.

In still other words, alternating and pulsed voltages may merge to alternating and continuous voltages such that length of the passive periods of each of the alternating and pulsed voltages becomes substantially zero.

Alternating and pulsed voltages of each of the inductance coils 61a may merge to alternating and continuous voltages for each of the inductance coils 61a such that length of the passive periods of each of the alternating and pulsed voltages of the voltages of each of the inductance coils 61a becomes substantially zero.

It has been surprisingly found that by arranging the bridging angular length 83 to be between 70% and 130% of the bridging angular separation 85, the inductance unit angular separation 86 to be between 70% and 130% of the bridging angular separation 85, and the bridging angular length 83 to be between 70% and 130% of the inductance unit angular length 84, a substantially alternating and continuous voltage waveform is generated at each of the inductance coils 61a of the inductance units 61 as the rotor 50 rotates.

As a special case and an embodiment, the bridging angular length 83 is 100%, that is, equal the bridging angular separation 85, the inductance unit angular separation 86 is equal to the bridging angular separation 85, and the bridging angular length 83 is equal to the inductance unit angular length 84, making both angular separations 86 and 85, and both angular lengths 83 and 84 equal.

In an embodiment, and as shown in FIGS. 3a and 3b, the at least one bridging element 51 and the at least one inductance unit 61 are aligned in the circumferential direction CF.

The bridging angular separation 85 (α1) is an angle which a separation between two adjacent bridging elements 51 spans in the circumferential direction CF, relative to the rotation axis X.

The bridging angular separation 85 is constant over the whole circumference of the rotor 50 for the bridging elements 51.

Thus, the bridging angular separation 85 is a predetermined bridging angular separation 85.

In other words, each bridging element 51 is separated from an adjacent bridging element 51 with the same bridging angular separation 85.

The bridging angular length 83 (θ1) is an angle α bridging element spans between its two ends in the circumferential direction CF, relative to the rotation axis X.

The bridging angular length 83 is constant over the whole circumference of the rotor 50 for the bridging elements 51.

Thus, the bridging angular length 83 is a predetermined bridging angular length 83.

In other words, each bridging element 51 has the same bridging angular length 83.

The inductance unit angular separation 86 (α2) is an angle which a separation between two adjacent inductance units spans in the circumferential direction CF relative to the rotation axis X.

The inductance unit angular separation 86 is constant over the whole circumference of the inductance unit holder 60 for the inductance units 61.

Thus, the inductance unit angular separation 86 is a predetermined inductance unit angular separation 86.

In other words, each inductance unit 61 is separated from an adjacent inductance unit 61 with the same inductance unit angular separation 86.

The inductance unit angular length 84 (θ2) is an angle an inductance unit 61 spans between two ends of the inductance unit 61 in the circumferential direction CF, relative to the rotation axis X.

The inductance unit angular length 84 is constant over the whole circumference of the inductance unit holder 60 for the inductance units 61.

Thus, inductance unit angular length 84 is a predetermined inductance unit angular length 84.

In other words, each inductance unit 61 has the same inductance unit angular length 84.

Merging of the alternating and pulsed voltages is illustrated with waveforms 6104VC, 6105VC and 6106VC in FIGS. 3a and 3b that illustrate the voltages of the inductance coils 61a of inductance units 6104-6106, respectively.

In an embodiment related to the generator 10, and for illustration, turning specifically to FIG. 3a, the rotor 50 comprises a predetermined number N_{B} of bridging elements 51 and the inductance unit holder 60 comprises a predetermined number N_{I} of inductance units 61 such that the predetermined number of bridging elements N_{B} is equal to the predetermined number N_{I} of inductance units 61, whereby the alternating and pulsed voltages of all the inductance coils 61a of the inductance units 61 have a same phase and have a pulse frequency, the pulse frequency being the predetermined number of bridging elements N_{B} multiplied by the rotation frequency 88 of the rotor 50.

In FIG. 3a, the inductance units are numbered from 1 to 8 as 6101-6108, respectively. Similarly, the bridging elements 51 are numbered from 1 to 8 as 5101-5108. Thus, there are 8 inductance units 61 and 8 bridging elements 51 illustrated in FIG. 3a.

In an embodiment related to the generator 10, and for illustration, turning to e.g. FIG. 2, FIG. 3b, FIG. 4, and FIG. 5, the rotor 50 comprises a predetermined number N_{B} of bridging elements 51 and the inductance unit holder 60 comprises a predetermined number N_{I} of inductance units 61 such that the predetermined number of bridging elements N_{B} is not equal to the predetermined number N_{I} of inductance units 61. In this case, the alternating and pulsed voltages of the inductance coils 61a of each of the inductance units 61 have at least two different phases, and have a same pulse frequency. The pulse frequency is the predetermined number of bridging elements N_{B} multiplied by the rotation frequency 88 of the rotor 50.

In an embodiment related to the generator 10, the rotor 50 comprises a predetermined number N_{B} of bridging elements 51 and the inductance unit holder 60 comprises a predetermined number N_{I} of inductance units 61 such that the predetermined number of bridging elements N_{B} is one more than the predetermined number N_{I} of inductance units 61, whereby the alternating and pulsed voltages of the inductance coils 61a of each of the inductance units 61 have a number of phases which equals to the predetermined number N_{I} of inductance units 61, and a pulse frequency which is the predetermined number of bridging elements N_{B} multiplied by the rotation frequency 88 of the rotor 50. This embodiment is very advantageous as it decreases the amount of overlap of the bridging elements 51 relative to the inductance units 61 at any one rotation angle of the rotor. Thus, the amount of force or torque required to start a stagnant rotor 50 to rotate is decreased as less magnetic inductance units 61 and bridging elements 51 are exactly opposing each other at any one time, thus being attracted by magnetic forces.

In an embodiment related to the generator 10, the rotor 50 comprises a predetermined number N_{B} of bridging elements 51 and the inductance unit holder 60 comprises a predetermined number N_{I} of inductance units 61 such that the predetermined number of bridging elements N_{B} is one less than the predetermined number N_{I} of inductance units 61, whereby the alternating and pulsed voltages of the inductance coils 61a of each of the inductance units 61 have a number of phases which equals to the predetermined number N_{I} of inductance units 61, and a pulse frequency which is the predetermined number of bridging elements N_{B} multiplied by the rotation frequency 88 of the rotor 50. An example of this embodiment is shown in FIG. 3b where the predetermined number of inductance units 61 is 8, and the predetermined number of bridging elements N_{B} is 7 (7=8−1). This embodiment is also very advantageous as it decreases the amount of overlap of the bridging elements relative to the inductance units at any one rotation angle of the rotor. Thus, the amount of force or torque required to start a stagnant rotor to rotate is decreased as less magnetic inductance units 61 and bridging elements 51 are opposing each other, being attracted by magnetic forces.

Turning next to FIG. 6a and FIG. 6b, in an embodiment related to the generator 10, as the at least one bridging element 51 is arranged to rotate about a rotation axis X, the at least one bridging element 51 is arranged into a rotational movement that causes the at least one bridging element 51 to arrange a magnetic circuit 90 to alternate between an open state 90o, in which the magnetic circuit 90o is formed of the inductance unit 61 and of at least one substance 61s which at least partially surrounds the inductance unit 61, and a closed state 90c, in which the magnetic circuit 90c is formed of the bridging element 51, of the inductance unit 61 and of the at least one substance 61s which at least partially surrounds the inductance unit 61.

When the magnetic circuit is in the closed state 90c, as shown in FIG. 6a, the at least one substance 61s fills, at least partially, the gap or gaps between the bridging element 51 and the inductance unit 61.

When the magnetic circuit is in the open state 90o, as shown in FIG. 6b, magnetic flux of the magnetic circuit arches in the at least one substance 61s to complete the magnetic circuit 90, as in the open state 90o, the magnetic circuit 90 is void of the bridging element 51.

In an embodiment of the generator, the at least one substance 61s which at least partially surrounds the inductance unit 61 comprises the fluid of the fluid flow operating the rotor 50. This is very advantageous, as the rotating parts like the rotor 50 and the bridging elements 51 of the generator can be immersed into the fluid of the fluid flow completely. Thus, sealing the inductance units 61 from the fluid flow is very simple. Movement of the fluid does not alter the behaviour of the magnetic flux through the flowing fluid in any significant way, nor the capacity of the alternating magnetic flux to generate electricity.

Through the alternating states 90c, 90o of the magnetic circuit 90, a voltage is induced to the inductance coil 61a of the inductance unit 61.

Related to FIG. 6a and FIG. 6b, as is well known, Faraday's law of induction states that a changing magnetic flux density −dΦ/dt generates an electromotive force, that is, a voltage U such that U is proportional to −dΦ/dt. This is the basic working principle of all electric generators in which mechanical energy is converted into electrical energy, that is, electricity.

A closed magnetic circuit 90c can be defined as a closed path of magnetic flux B along a structure comprising a loop 92 and a ferromagnetic material. The mechanical shape of the structure 90c and the loop 92 of the structure defines the shape of the magnetic flux lines, as the magnetic flux B stays substantially within the structure due to the ferromagnetic properties of the structure, as ferromagnetic material has usually a large relative permeability UR and thus large permeability μ=μ_{R} μ₀, where μ₀ is the permeability of free space. This is illustrated in FIG. 6a that shows a horseshoe-like inductance unit 61 carrying a magnetic flux density Φ1. However, many other shapes for the inductance unit 61 are possible.

The inductance unit 61 comprises a core 61c, and at least one inductance coil 61a.

The inductance unit 61 is closed with a bridging element 51, the bridging element also carrying a magnetic flux density Φ1. Thus, as shown in FIG. 6a, the magnetic circuit 90c is in a closed state.

The loop of the structure may have e.g. two closed state gaps 91c (e.g. filled with air) between the inductance unit 61 and the bridging element 51. Length of one closed state gap is L_{G}. A small gap allows the rotor 50 to rotate and not get stuck.

With a cross section S in the core 61c of the inductance unit 61 and in the bridging element 51, the magnetic flux B is equal to Φ₁S, that is, B=Φ₁S. However, according to the invention, cross sections of the core 61c and the bridging element 51 may be different.

Magnetic flux B may be created to the magnetic circuit in many ways. As shown in FIG. 6a, the core 61c may be a permanent magnet, e.g. a horseshoe magnet with magnetic poles NO (for north) and SO (for south).

Alternatively or additionally, the core 61c may comprise permanent magnet portion 61b, which is a permanent magnet, arranged to generate the magnetic flux B into the magnetic circuit 90c.

In both cases, core 61c being a permanent magnet, or the core 61c comprising a permanent magnet portion 61b, the core 61c comprises a permanent magnet.

Still alternatively or additionally, the core 61c may comprise portion which is an electromagnet 61e arranged to generate the magnetic flux B into the magnetic circuit 90c.

An electromagnet 61e may be arranged e.g. by winding a magnetisation coil around the core 61c and feeding a current, e.g. a DC current, into the magnetisation coil. Thus, the core 61c may comprise an electromagnet 61e. The bridging element 51 may also comprise a permanent magnet arranged to generate a magnetic flux B into the magnetic circuit 90c.

The bridging element 51 may also comprise ferromagnetic material void of permanent magnetization.

The bridging element 51 may also comprise both a ferromagnetic material and a permanent magnet.

Without limiting the present text into any physical theory, a following explanation for the production of electricity in the invention is offered: A reasonable approximation for the magnetic flux density Φ₁ (and magnetic flux B assuming a constant cross section area S in the core 61c and in the bridging element 51) in the closed magnetic circuit 90c is as follows: The electromagnet 61e may have, in its magnetization coil, N_{E} turns carrying a current I_{E}. Thus, the electromagnet 61e generates a magnetomotive force V_{M} into the closed magnetic circuit 90c, V_{M}=N_{E} I_{E}.

Also permanent magnet in the core 61c or in the bridging element 51 creates an equivalent magnetomotive force V_{M} into the magnetic circuit 90c.

Applying Ampere's circuital law in the loop 92 we have the following: [symbol] ·H dl=N_{E} I_{E}, where H is the magnetic field strength and, the integral is taken along the loop 92′ denoted with the dashed line, the entire loop 92′ having length L (including the closed state gaps 91c). Magnetic flux B (and the magnetic flux density) is constant in the loop 92, and thus in the core the magnetic field strength is H_{C}=B/μ, where μ=μ_{R} μ₀, μ_{R} being the relative permeability of the ferromagnetic core, and in the gaps, H_{G}=B/μ₀, by assuming that the gap has insignificant, close-to-one relative permeability, e.g. is filled by air.

Now the following holds per Ampere's circuital law: B(L−2L_{G})/μ+2BL_{G}/μ₀=V_{M}, as there are two closed state gaps 91c with length L_{G}. This gives for the magnetic flux density Φ₁=V_{M}/[(L−2L_{G})/Sμ+2L_{G}/Sμ₀], or by stating the reluctances of the core and two closed state gaps 91c, as, R_{C}=(L−2L_{G})/Sμ and R_{G}=2L_{G}/Sμ₀, we arrive in Φ₁=V_{M}/(R_{C}+R_{G}).

In figure FIG. 6b, the magnetic circuit 90o is in an open state. In the open state, the magnetic circuit 90o is void of the bridging element 51. Thus, a long gap or open state gap 91o of length L_{O} is created into the magnetic circuit 90, which considerably lowers the magnetic flux density to a value Φ₂ which may be approximated with Φ₂=V_{M}/[(L−L_{O})/Sμ+L_{O}/Sμ₀].

Approximation of the magnetic flux density in the open state of the magnetic circuit 90o is less accurate than in the closed state 90c owing to the large gap 91o and considerable magnetic stray field lines at the open gap not directed and focused by the ferromagnetic material, but it may serve to illustrate the theory of function of the magnetic circuit 90 and its ability to generate electricity.

Magnetic flux density Φ₂ in the open state of the magnetic circuit 90 is lower due to larger total reluctance R_{CO}+R_{GO}, where R_{CO}=(L−L_{O})/Sμ and R_{GO}=L_{O}/Sμ₀ in the open magnetic circuit.

Thus, the magnetic flux density of the magnetic circuit 90 alternates between the open state magnetic circuit 90o Φ₂, and the closed state magnetic circuit 90c Φ₁. If the change from an open state to a closed state occurs in time t, electromotive force −(Φ₂−Φ₁) S/t is induced, and for an inductance coil 61a with a winding of N turns in the magnetic circuit 90, 90o, a transient voltage U at the terminals of the inductance coil 61a may be approximated with U=−N(Φ₂−Φ₁) S/t.

As the magnetic flux density is arranged to change with differences Φ₂−Φ₁ and Φ₁−Φ₂, an alternating and pulsed voltage is generated in the inductance coil 61a. During the periods of no change, that is, during the times the magnetic circuit is completely open, such that the bridging element 51 is not in the vicinity of the inductance unit 61, or completely closed, such that the bridging element 51 completely or at least partially covers the end of the core 61c of the inductance unit 61, there is substantially no change in the magnetic flux density, and thus the voltage, during periods of no change, stays substantially zero.

Thus, when the generator operates, the voltage of each of the inductance coils 61a is not necessarily alternating and continuous, but always alternating and pulsed.

The alternating and pulsed voltage may merge to an alternating and continuous voltage.

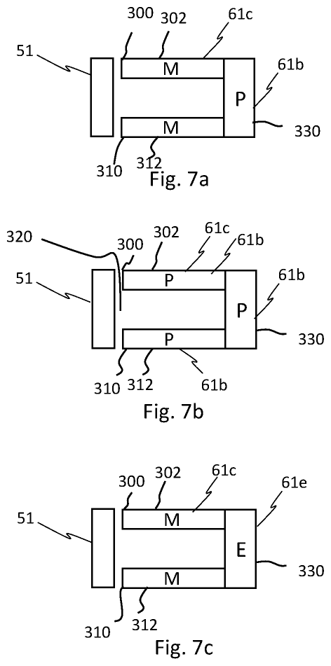

Turning to FIG. 7a, in an embodiment related to the generator 10, the core 61c of the inductance unit 61 comprises ferromagnetic material, and the core 61c of the inductance unit 61 comprises a permanent magnet portion 61b.

A permanent magnet portion may be, for example a neodymium magnet, or a samarium-cobalt magnet.

Turning to FIG. 7b, in an embodiment related to the generator 10, the core 61c of the inductance unit 61 comprises ferromagnetic material, and the core 61c of the inductance unit 61 is a permanent magnet 61b.

Turning to FIG. 7c, in an embodiment related to the generator 10, the core 61c of the inductance unit 61 comprises ferromagnetic material, and the core 61c of the inductance unit 61 comprises an electromagnet 61e.

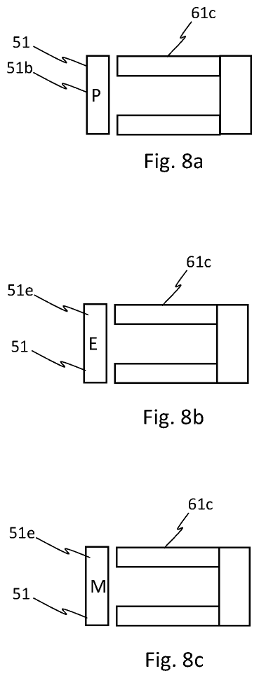

Turning to FIG. 8a, in an embodiment related to the generator 10, the bridging element 51 comprises a permanent magnet 51b.

Turning to FIG. 8b, in an embodiment related to the generator 10, the bridging element 51 comprises an electromagnet 51e. The electromagnet 51e can be provided to the bridging element 51 by supplying, through electrical connections, a current, e.g. a DC current, with a conductor coiled around a ferromagnetic electromagnet core, providing the electromagnet 51e to the ferromagnetic electromagnet core of the bridging element 51.

Turning to FIG. 8c, in an embodiment related to the generator 10, the bridging element 51 comprises ferromagnetic material.

Turning still to FIG. 8c, and referring to FIG. 6b, in an embodiment related to the generator 10, in the open state 90o of the magnetic circuit, the bridging element 51 is unmagnetized.

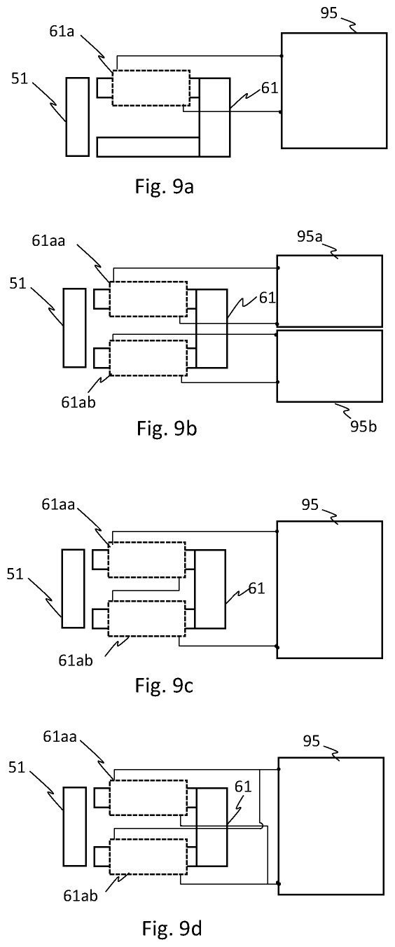

Turning next to FIG. 9a, in an embodiment related to the generator 10, the generator 10 comprises at least one rectifier 95, the at least one rectifier 95 comprising alternating voltage input nodes and rectified voltage output nodes, the inductance unit 61 comprising one inductance coil 61a connected to the alternating voltage input nodes of the rectifier 95.

Turning next to FIG. 9b, in an embodiment of the generator 10, the generator 10 comprises at least one rectifier 95, the at least one rectifier 95 comprising alternating voltage input nodes and rectified voltage output nodes. The inductance unit 61 comprises a first inductance coil 61aa and a second inductance coil 61ab, the first inductance coil 61aa connected to the alternating voltage input nodes of a first rectifier 95a, and the second inductance coil 61ab connected to the alternating voltage input nodes of a second rectifier 95b.

Turning next to FIG. 9c, in an embodiment of the generator 10, the generator 10 comprises at least one rectifier 95, the at least one rectifier 95 comprising alternating voltage input nodes and rectified voltage output nodes. The inductance unit 61 comprises a first inductance coil 61aa and a second inductance coil 61ab arranged in a series connection, the series connection connected to the alternating voltage input nodes of the at least one rectifier 95.

Turning next to FIG. 9d, in an embodiment of the generator 10, the generator 10 comprises at least one rectifier 95, the at least one rectifier 95 comprising alternating voltage input nodes and rectified voltage output nodes. The inductance unit 61 comprises a first inductance coil 61aa and a second inductance coil 61ab arranged in a parallel connection, the parallel connection connected to the alternating voltage input nodes of the at least one rectifier 95.

According to the above mentioned and in the context of this application, the inductance unit 61 comprises the core 61c. The core 61c comprises a first end 300 and a second end 310. The first end 300 and the second 310 are arranged at distance from each other, as shown in FIGS. 7a, 7b and 7c. The core 61c forms an open loop having an open portion 320 between the first end 300 and the second end 310 of the core 61c.

The core 61c further comprises a first end part 302 having the first end 300 and a second end part 312 having the second end 310, as shown in FIGS. 7a, 7b and 7c

The core 61c may further comprise a base part or intermediate part 330 provided between the first and second end parts 302, 312m as shown in FIGS. 7a, 7b and 7c.

The first inductance coil 61a is provided to and around the first end part 302 of the core 61c, or to and around the second end part 312 of the core 61c.

Alternatively, the first inductance coil 61a is provided to and around the first end part 302 of the core 61c, and the second inductance coil 61a is provided to and around the second end part 312 of the core 61c.

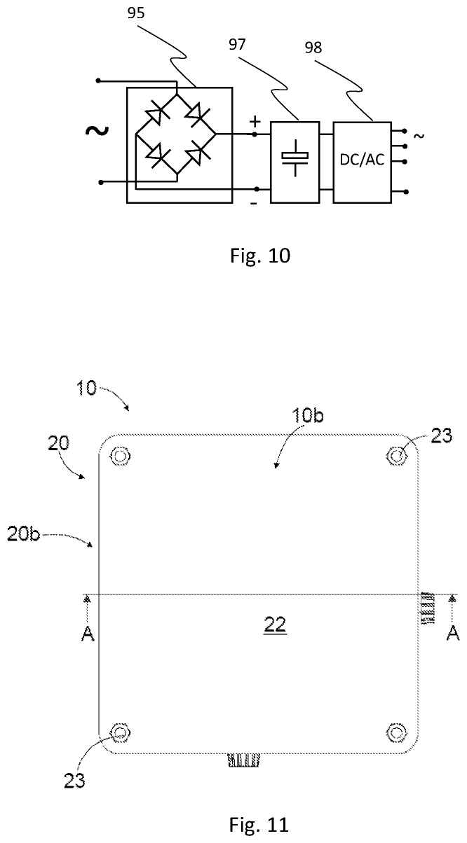

The bridging elements 51 are arranged to pass the inductance units 61 during rotation of the rotor 50 such that the bridging elements pass the open portion 320 of the of the core 61c. The bridging elements 51 are arranged to close the magnetic circuit 90 as the bridging element passes the open portion 320 of the core 61c during rotation. Turning now to FIG. 10, in an embodiment of the generator 10, the generator 10 comprises at least one electrical energy storage unit 97 connected to the rectified voltage output nodes of the at least one rectifier 95.

Still referring to FIG. 10, in an embodiment of the generator 10, the generator 10 comprises at least one electrical energy storage unit 97 connected to the rectified voltage output nodes of the at least one rectifier 95, and at least one inverter 98 arranged to convert rectified voltage of the at least one electrical energy storage unit 97 to an alternating output voltage.

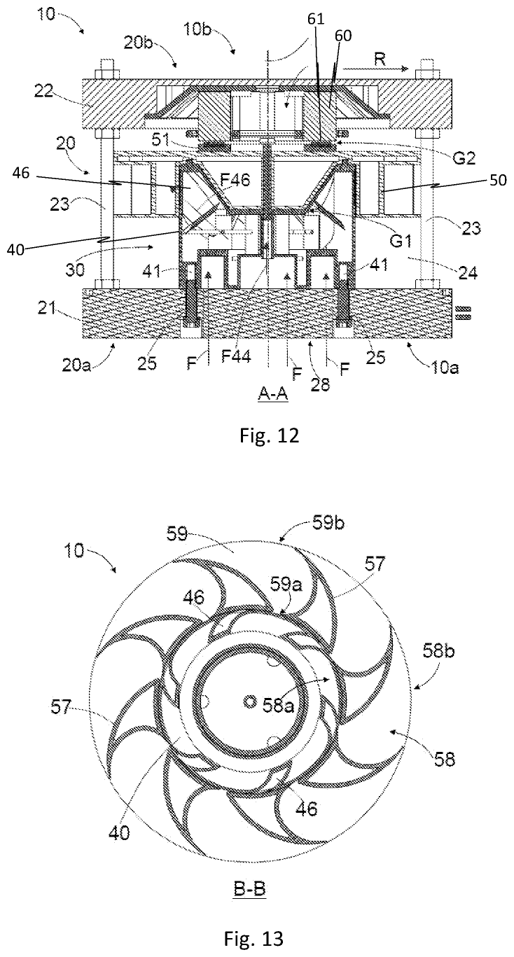

FIG. 1 is a schematic side view of a generator 10, FIG. 11 is a schematic top view of the generator 10 of FIG. 1, FIG. 12 is a schematic cross sectional side view of the generator 10 of FIGS. 11 and 12 along the line A-A in FIG. 11, and FIG. 13 is a schematic cross-sectional top view of parts of the generator 10 of FIGS. 1 and 12 along the line B-B in FIG. 1.

Turning to FIG. 12, in an embodiment of the generator 10, the flow channel unit 40 and the rotor 50 have a common axial direction X, and the flow channel unit 40 and the rotor 50 are arranged in the axial direction X substantially successively to each other.

Accordingly, the rotation axis of the rotor 50 and the axial direction of the flow channel are arranged parallel to each other. Thus, the fluid flow is arranged to be conveyed to the rotor 50 in axial direction.

In preferred embodiments, the rotation axis of the rotor 50 and the axial direction of the flow channel are arranged concentric and parallel to each other. Thus, the fluid flow is arranged to be conveyed to the rotor 50 in axial direction.

Still referring to FIG. 12, in an embodiment of the generator 10, the rotor 50 is arranged to rest on the flow channel unit 40 when the generator 10 is not in use, and to float relative to the flow channel unit 40 when the generator 10 is in operation.

For the rotor 50 to rotate in a floating bearing manner, it means that the rotor 50 is arranged to float relative to the flow channel unit 40 when the generator is in operation.

In reference to FIGS. 1, 12, and 16-19, in an embodiment of the generator 10, the flow channel unit 40 comprises at least one channel 44 for conveying at least one fluid flow between the flow channel unit 40 and the rotor 50 to create a pressure effect between the flow channel unit 40 and the rotor 50 to push, in the axial direction X of the flow channel unit 40 and the rotor 50, the rotor 50 away from the flow channel unit 40 such that a gap G1 is arranged between the flow channel unit 40 and the rotor 50 for allowing the rotor 50 to rotate relative to the flow channel unit 40 substantially friction-free. The flow channel unit 40 comprises at least one channel 46 for conveying at least one fluid flow to the rotor 50 for rotating the rotor 50.

In reference to FIG. 12, in an embodiment of the generator 10, the rotor 50 is arranged to at least partly surround the flow channel unit 40.

In reference to FIGS. 17-19, in an embodiment of the generator 10, the at least one channel 46 conveying at least one fluid flow to the rotor 50 for rotating the rotor 50 is arranged to extend in the flow channel unit 40 in at least partly radial direction R such that an outlet opening 46b of the channel 46 is arranged at an outer periphery of the flow channel unit 40 at the position of the rotor 50 in an axial direction X of the flow channel unit 40.

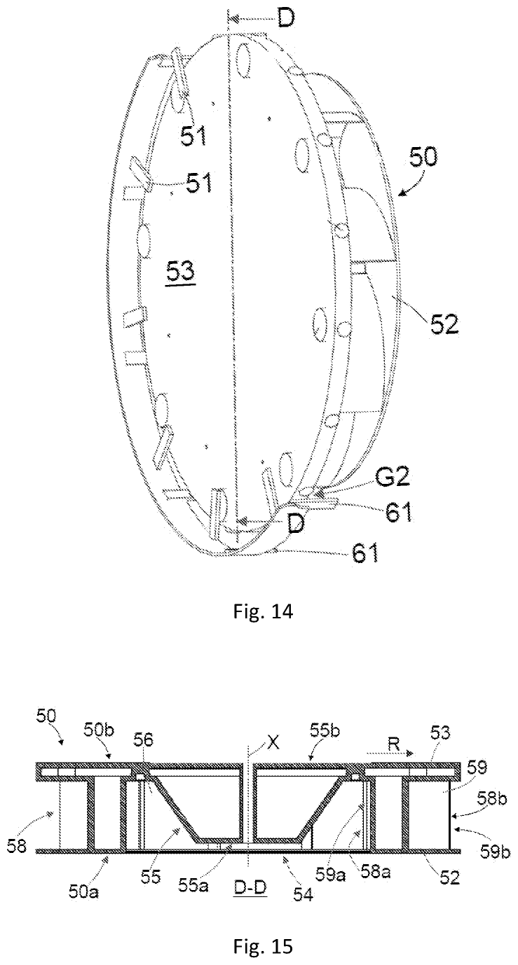

In reference to FIGS. 14-15, in an embodiment of the generator 10, the at least one rotor 50 comprises a number of rotor flow channels 59 extending in at least partly radial direction R of the rotor 50, the fluid flow flowing through the rotor flow channels 59 for rotating the rotor 50.

To illustrate the generator 10 further, and referring back to FIG. 1, the generator 10 has an axial direction X and in the axial direction X a first end 10a and a second end 10b.

The axial direction X may also denote a center axis of the generator 10.

A radial direction R of the generator 10 is a direction substantially transverse (perpendicular) to the axial direction X.

The generator 10 comprises a frame 20 and a power generating unit 30 supported to the frame 20. The power generating unit 30 is intended to convert a kinetic energy of at least one fluid flow supplied into the generator 10 to the electric energy.

The frame 20 has an axial direction that substantially coincides with the axial direction X of the generator 10. Therefore, the axial direction of the frame 20 and a center axis of the frame 20 may also be denoted with the reference sign X.

The frame 20 comprises a first end plate 21 at the first end 10a of the generator 10 and a second end plate 22 at the second end 10b of the generator 10, the second end plate 22 thus being at a distance from the first end plate 21 in the axial direction X of generator 10.

The first end plate 21 provides a first end 20a of the frame 20 that in the embodiment of the generator 10 provides the first end 10a of the generator 10, and the second end plate 22 provides a second end 20b of the frame 20 that in the embodiment of the generator 10 provides the second end 10b of the generator 10. The frame 20 further may comprise a number of support rods 23, in the embodiment related to FIG. 1 altogether four support rods 23, running substantially parallel to the axial direction X between the first end plate 21 and the second end plate 22. The support rods 23 fastens the first end plate 21 and the second end plate 22 to each other such that a space 24 for accommodating the power generating unit 30 is provided by the first end plate 21, the second end plate 22 and the support rods 23.

The power generating unit 30 has an axial direction that coincides with the axial direction X of the generator 10. Therefore, the axial direction of the power generating unit 30 and a center axis of the power generating unit 30 may also be denoted with the reference sign X.

The power generating unit has, in the axial direction X thereof, a first end 30a facing towards the first end 10a of the generator 10 and a second end 30b facing towards the second end 10b of generator 10.

A radial direction R of the power generating unit 30 is a substantially transverse to the axial direction X.

The power generating unit 30 has a stationary flow channel unit 40, a rotatable rotor 50 provided with at least one bridging element 51. The power generating unit 30 has at least one, i.e., one or more stationary inductance units 61.

The one or more stationary inductance units 61 may be arranged in an inductance unit holder 60.

The flow channel unit 40 and the rotor 50 may be arranged substantially successively to each other in the axial direction X of the power generating unit 30.

The flow channel unit 40 and the rotor 50 may be arranged substantially consecutively to each other in the axial direction X of the power generating unit 30.

The rotor 50 may be arranged at least partly around the flow channel unit 40.

Other embodiments, wherein the rotor 50 is not at least partly arranged around the flow channel unit 40 are, however, possible.

The flow channel unit 40 is arranged to convey at least one fluid flow to the rotor 50 for causing the rotor 50 to operate, i.e., to rotate.

In response to a rotation of the rotor 50, the at least one bridging element 51 arranged to the rotor 50 also rotates along at least one respective circumferential path about the center axis X of the power generating unit 30. The rotation of the at least one bridging element 51 along with the rotating rotor 50 is arranged to provide a magnetic field rotating in respect of the at least one stationary inductance unit 61, thus causing electromotive force, i.e., voltage, being induced in the inductance unit 61.

The bridging element 51 is an element comprising or being composed of ferromagnetic material. Preferably the bridging element 51 is a piece of iron or a piece of other ferromagnetic material or composite comprising ferromagnetic material.

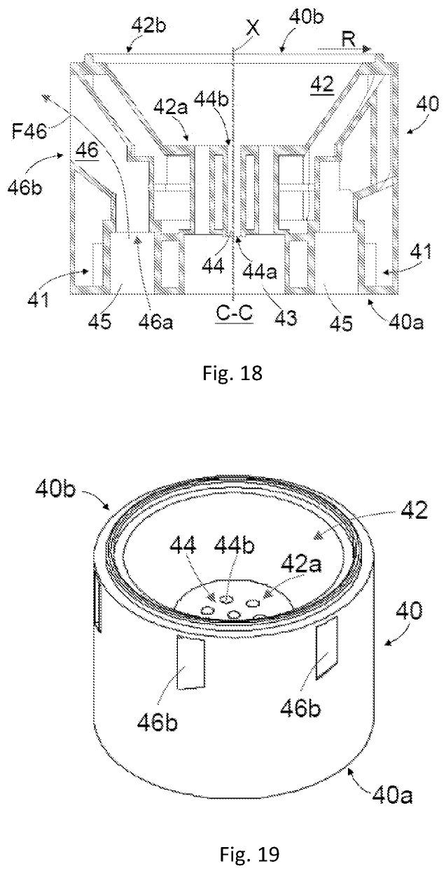

The power generating unit 30 is fastened to the first end plate 21 of the frame 20 of the generator 10 by fastening bolts 25 inserted into respective fastening openings 41 in the flow channel unit 40 (as illustrated e.g. in FIGS. 12 and 18). Other fastening means may also be provided.

The flow channel unit 40 is thus fixed to the frame 20 of the generator such that the flow channel unit 40 is stationary.

The one or more inductance units 61 are mounted to the inductance unit holder 60 in such a way that the one or more inductance units 61 are stationary.

The inductance unit holder 60 may be fixed to the generator 10.

The inductance unit holder 60 may be fixed to the power generating unit 30.

The rotor 50, that is arranged to be operated in response to fluid flow flowing to the rotor 50, may thus the only rotating part in the power generating unit 30 or, generally, in the generator 10.

The power generating unit 30 may thus consist of three main parts, i.e., the flow channel unit 40, the rotor 50, wherein the at least one bridging element 51 is arranged to, and the inductance unit holder 60 arranged to hold the at least one inductance unit 61.

The flow channel unit 40 and the frame 20, with the inductance unit 61, may be stationary and only one part, i.e., the rotor 50, may be a rotating part.

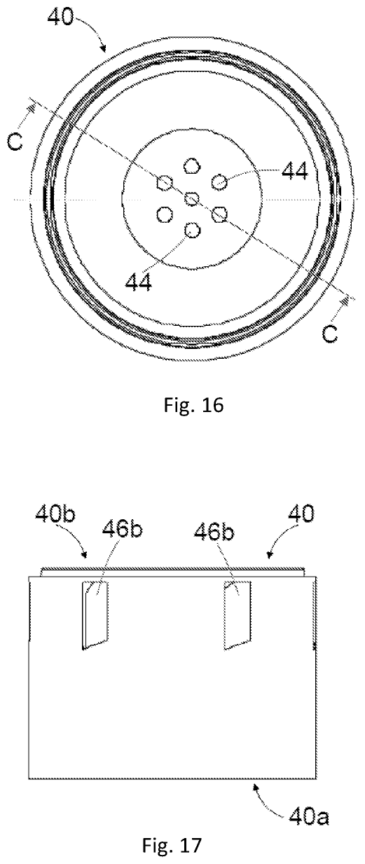

FIG. 16 is a schematic bottom view of the flow channel unit 40 of the power generating unit 30. FIG. 17 is a schematic side view of the flow channel unit 40 of FIG. 16. FIG. 18 is a schematic cross-sectional side view of the flow channel unit 40 of FIGS. 16 and 17 along the line C-C in FIG. 16. FIG. 19 shows schematically the flow channel unit 40 of FIGS. 16 to 18 as seen obliquely from above.

The flow channel unit 40 has an axial direction that substantially coincides with the axial direction X of the generator 10 and of the power generating unit 30. Therefore, the axial direction of the flow channel unit 40 and a center axis of the flow channel unit 40 may also be denoted with the reference sign X.

A radial direction R of the flow channel unit 40 is a direction substantially transverse to the axial direction X.

As in FIGS. 17-19, the flow channel unit 40 has, in the axial direction X thereof, a first end 40a intended to face towards the first end 10a of the generator or the first end plate 21 of the frame 20 of the generator 10, the first end 40a of the flow channel unit 40 providing the first end 30a of the power generating unit 30.

The flow channel unit 40 has, in the axial direction X thereof, a second end 40b intended to face towards the second end 30b of the power generating unit or towards the rotor 50.

At the second end 40b of the flow channel unit 40 there is a chamber 42 having a shape of a truncated cone extending towards the first end 40a of the flow channel unit 40, a first end 42a of the chamber 42 having a smaller diameter and being directed towards the first end 40a of the flow channel unit 40 and a second end 42b of the chamber 42 having a larger diameter and being directed towards the second end 40b of the flow channel unit 40 or towards the rotor 50.

The first end 42a of the chamber 42 is a substantially planar circular plate the center of which substantially coincides with the center axis X of the flow channel unit 40.

The second end 42b of the chamber 42 is substantially an open circle, that is, a substantially circular opening facing towards the second end 40b of the flow channel unit 40, i.e., towards the rotor 50, a center of the second end 42b of the chamber 42 substantially coinciding with the center axis X of the flow channel unit 40.

The flow channel unit 40 comprises a channel system intended to direct at least one fluid flow received by the flow channel unit 40 towards the rotor 50 to operate the rotor 50.

The channel system of the flow channel unit 40, as shown in various embodiments of FIGS. 16-19, comprises substantially at the first end 40a of the flow channel unit 40 at least one first inlet flow channel 43 and at least one second inlet flow channel 45 that is, in the radial direction R of the flow channel unit 40, farther away from a center of the flow channel unit 40 than the at least one first inlet flow channel 43.

The at least one first inlet flow channel 43 and the at least one second inlet flow channel 45 are intended to receive into the flow channel unit 40 at least one fluid flow for operating the rotor 50.

In an embodiment, there is one first inlet flow channel 43 and six second inlet flow channels 45 arranged to surround the first inlet flow channel 43.

The channel system of the flow channel unit 40 comprises a set of first sub-channels 44 (as in FIGS. 16-18) extending from the first inlet flow channel 43 up to the chamber 42, each first sub-channel 44 having an inlet opening 44a at the first inlet flow channel 43 and an outlet opening 44b at the first end 42a of the chamber 42, the outlet opening 44b extending through the plate providing the first end 42a of the chamber 42.

The number of the first sub-channels 44 in FIGS. 16-19 is seven but this number may vary from one to more, depending on, for example, the size or nominal power of the power generating unit 30.

The fluid flow provided through the first sub-channels 44 is intended to provide a small gap G1 or clearance (as shown e.g. in FIG. 12) between the flow channel unit 40 and the rotor 50 to allow the rotor 50 to float in the fluid flow and to rotate substantially freely, i.e., almost friction-free or at very low total efficient of the friction, relative to the flow channel unit 40. In other words, the rotor 50 is arranged to rotate relative to the flow channel unit 40 in a floating bearing manner.

The channel system of the flow channel unit 40 further comprises a set of second sub-channels 46 (illustrated e.g. in FIGS. 12 and 18) extending from the second inlet flow channels 45 up to the outer circumference of the flow channel unit 40 substantially at the second end 40b of the flow channel unit 40, each second subchannel 46 having an inlet opening 46a at the second inlet flow channel 45 and an outlet opening 46b at the outer circumference of the flow channel unit 40 substantially at the second end 40b of the flow channel unit 40, in the axial direction X of the flow channel unit 40, at a position of the flow channel unit 40 to be surrounded by the rotor 50.

In the embodiment, the second sub-channels 46 are arranged to extend in at least partly radial direction R such that the outlet openings 46b of the second sub-channels 46 are arranged at an outer periphery of the flow channel unit 40, substantially at the position of the rotor 50, in the axial direction X of the flow channel unit 40.

The number of the second sub-channels 46 in may be e.g. six, but this number may vary from one to more depending on for example the size or nominal power of the power generating unit 30.

The fluid flow provided through the second sub-channels 46 is intended to cause the rotor 50 to rotate around its rotation axis, i.e., around the centre axis X of the rotor 50.

FIG. 14 shows schematically a projection view of an embodiment of the rotor 50.

FIG. 15 shows schematically a cross-sectional side view of the rotor of FIG. 14 along the line or cutting plane D-D in FIG. 14.

The one or more bridging elements 51 shown in FIG. 14 are omitted in FIG. 15.

The rotor 50 has an axial direction that substantially coincides with the axial direction X of the generator 10 and of the power generating unit 30. Therefore, the axial direction of the rotor 50 and a centre axis of the rotor 50, providing a fictitious rotating axis of the rotor 50, may also be denoted with the reference sign X.

A radial direction R of the rotor 50 is a direction substantially transverse to the axial direction X.

The rotor 50 has, in the axial direction X thereof, a first end plate 52 forming a first end 50a of the rotor 50, the first end 50a of the rotor 50 facing towards the first end 30a of the power generating unit 30 and the first end 40a of the flow channel unit 40.

The rotor 50 has, in the axial direction X thereof, a second end plate 53 forming a second end 50b of the rotor 50 facing towards the second end 30b of the power generating unit 30.

The first end plate 52 of the rotor 50 comprises an opening 54 at a centre area of the first end plate 52.

The second end plate 53 of the rotor 50 comprises, at a centre area of the second end plate 53, an extension 55 internal in the rotor 50. The extension 55 has a shape of a truncated cone extending from the second end plate 53, i.e., from the second end 50b of the rotor 50, towards the opening 54 in the first end plate 52, i.e., towards the first end 50a of the rotor 50.

The extension 55 has a first end 55a with a smaller diameter and being directed towards the flow channel unit 40 and a second end 55b with larger diameter and being directed away from the flow channel unit 40, i.e., towards the second end 50b of the rotor 50.

The first end 55a of the extension 55 is a substantially planar, circular, solid plate, the centre of which substantially coincides with the centre axis X of the rotor 50.

The second end 55b of the extension 55 is substantially closed part of the second end plate 53 of the rotor 50, a centre of the second end 55b of the extension substantially coinciding with the centre axis X of the rotor 50.

The shape and dimensions of the extension 55 in the rotor 50 is arranged such that it provides a counterpart with the chamber 42 in the flow channel unit 40, whereby the chamber 42 in the flow channel unit 40 can at least partly receive or accommodate the extension 55 in the rotor 50.

The first end 55a of the extension 55 in the rotor 50 provides a counterpart surface for the first end 42a of the chamber 42 in the flow channel unit 40.

Around the extension 55 in the rotor 50 there is an open space 56 which is intended to receive or accommodate the upper part of the outer circumference of the flow channel unit 40 when the power generating unit 30 is assembled.

As shown in FIG. 13, the rotor 50 further comprises a number of wings 57 providing a wing ring 58. The wing ring 58 is provided with a number of wings 57 following to each other at a distance from each other in the circumferential direction of the rotor 50.

The wing ring 58 has an inner circumference 58a being substantially defined by an outer circumference of the open space 56 surrounding the extension 55, and an outer circumference 58b.

The outer circumference 58b is substantially defined by an outer circumference of the rotor 50.

The wings 57 are arranged to extend in a radial direction of the rotor 50, i.e., in the direction that is substantially transverse to the axial direction X of the rotor 50.

The wings are also arranged in a curved manner from the inner circumference 58a of the wing ring 58 towards the outer circumference 58b of the wing ring 58.

The neighbouring wings 57 in the circumferential direction of the wing ring 58 define therebetween a number of rotor flow channels 59 extending from the direction of the inner circumference 58a of the wing ring 58 towards the outer circumference 58b of the wing ring 58 in a curved manner.

Each flow channel 59 has an inlet opening 59a substantially at the inner circumference 58a of the wing ring 58, and an outlet opening 59b substantially at the outer circumference 58b of the wing ring 58.

The number of the rotor flow channels 59 may be e.g. eight but may vary depending on for example the size or nominal power of the power generating unit 30 or on the type and viscosity of the fluid.

The at least one inductance unit 61 is arranged and fixed in the inductance unit holder 60 in such a way that the inductance unit 61 is, at least temporarily and alternatingly, at an area of an influence of the bridging element 51 rotating with the rotor 50. However, the inductance unit 61 is arranged to be kept at least a small distance apart from the bridging element 51 in the rotor 50 such that the bridging element 51 can freely rotate relative to the inductance unit 61.

In other words, there is a small gap G2 or clearance between the inductance unit 61 and the bridging element 51. In response to the bridging element 51 rotating relative to the inductance unit 61 electromotive force, i.e., voltage, is induced in the inductance unit 61.

By connecting electrical power outputs to provide closed electric circuit, the voltage induced in the inductance unit 61, to the at least one inductance coil 61a of the inductance unit, provides the electric current output from the generator 10.

The number of the inductance units 61 in the embodiment may vary from one to more depending on for example the size or nominal power of the power generating unit 30.

As an example, and referring to FIG. 12, the generator 10 and the power generating unit 30 of the various Figures may be assembled, as follows: The rotor 50 is set on top of the flow channel unit 40 such that the chamber 42 in the flow channel unit 40 receives the extension 55 in the rotor 50, and the first end 42a of the chamber 42 in the flow channel unit 40 and the first end 55a of the extension 55 in the rotor 50 set substantially opposite to each other.

The rotor 50 is therefore arranged at least partly around the second end 40b of the flow channel unit 40 such that the inlet openings 59a of the rotor flow channels 59 coincide in the axial direction X of the power generating unit 30 with the outlet openings 46b of the second sub-channels 46 in the flow channel unit 40.

Thereafter, the flow channel unit 40 together with the rotor 50 is fastened to the first end plate 21 of the frame 20 of the generator 10 for example by fastening bolts 25, and the support rods 23 are also fastened to the first end plate 21 of the frame 20.

The assembly may be continued by fastening the inductance unit holder 60 to the second end plate 22 of the frame 20 of the generator 10 and thereafter by fastening the inductance unit holder 60 with the second end plate 22 of the frame to the support rods 23 such that a small gap G2 (e.g. as in FIG. 12) is left in the axial direction X of the power generating unit 30 between the bridging elements 51 in the rotor 50 and the inductance units 61 of the inductance unit holder 60.

Especially if the bridging element are arranged in the outer circumference 58b of the rotor, other ways of assembling the generator are also possible.

To illustrate the operation of the generator 10, the fluid flow, shown schematically in FIG. 12 with arrows denoted with reference sign F, is conveyed into the flow channel unit 40 at the first end 40a of the flow channel unit 40 through an opening 28 in the first end plate 21 of the frame 20 indicated schematically with broken lines.

In the flow channel unit 40 a portion of the fluid flow F will flow into the first sub-channels 44 through the inlet openings 44a of the first sub-channels 44 and further through the first sub-channels 44 into the chamber 42 through the outlet openings 44b of the first sub-channels 44.

The portion of the fluid flow flowing through the first sub-channels 44 into the chamber 42, as shown schematically in FIG. 12 with an arrow denoted with the reference sign F44, is arranged to provide in the chamber 42 a pressure effect between the first end 42a of the chamber 42 in the flow channel unit 40 and the first end 55a of the extension 55 in the rotor 50. The pressure effect causes the rotor 50 in the axial direction X to move a small distance away from the flow channel unit 40 such that a small gap G1, the position of which is denoted schematically in FIG. 12 with an arrow G1, will appear between the flow channel unit 40 and the rotor 50.

The pressure effect thus causes the rotor 50 to remain, i.e., to float, at a small distance from the flow channel unit 40 in the axial direction X.

Thus, the rotor 50 is arranged to rotate relative to the flow channel unit in a floating bearing manner.

In the flow channel unit 40, a portion of the fluid flow F will flow into the second sub-channels 46 through the inlet openings 46a, and through the second sub-channels 46 and the outlet openings 46b thereof tangentially further into the rotor flow channels 59 in the rotor 50 through the inlet openings 59a of the rotor flow channels 59, as shown schematically in FIG. 12 with an arrow denoted with the reference sign F46.

Furthermore, the fluid flow F46 flows through the rotor flow channels 59 and the outlet openings 59b of the rotor flow channels 59 out of the rotor 50, in a substantially radial direction R of the rotor, causing the rotor 50 to rotate due to the interaction between the pressure of the fluid flow F46 and the wings 57 in the rotor 50.

The positioning of the outlet openings 46b of the second sub-channels 46 on the outer circumference of the flow channel unit 40 and the number of the second sub-channels 46 in the flow channel unit 40 and the number of the rotor flow channels 59 is selected such that even if in the power generating unit 30 the number of the second sub-channels 46 in the flow channel unit 40 and the number of the rotor flow channels 59 may deviate from each other, there is always, during the operation of the power generating unit 30, at least some second sub-channels 46 in the flow channel unit 40 that are in flow contact with at least some rotor flow channels 59 in the rotor 50, thus providing a constant rotation of the rotor 50.

In the power generating unit 30 disclosed above, the same fluid flow is utilized both to provide the pressure effect between the flow channel unit 40 and rotor 50 causing the rotor 50 to remain, i.e., to float, at a small distance from the flow channel unit 40 in the axial direction X of the power generating unit 30, as well as to rotate the rotor 50. The pressure effect between the flow channel unit 40 and rotor 50 causing the rotor 50 to remain, i.e., to float, at a small distance from the flow channel unit 40 in the axial direction X of the power generating unit 30 decreases friction between the flow channel unit 40 and the rotor 50, allowing the rotor 50 to rotate substantially or almost friction-free, i.e., at very low total coefficient of friction, about the flow channel unit 40. This solution thus provides a so-called floating bearing solution in the generator 10. This increases the efficiency in respect of traditional bearing solutions utilized in prior art generators, the operation and construction being, however, simple.

When the rotor 50 rotates, the bridging element 51 rotates in response to the rotation of the rotor 50, the bridging element 51 thereby rotating relative to the at least one inductance unit 61 and causing electromotive force, i.e. voltage, being induced in the inductance unit 61.

In an embodiment, when the electrical power outputs of the inductance coils 61a of the at least one inductance unit 61 are connected to provide closed electric circuit, the voltage, induced in the inductance unit 61 provides the electric current output from the generator 10.

According to an embodiment the inductance unit holder 60 may be equipped with a servo motor arrangement comprising at least one servomotor to control the size of the gap G2 between the bridging element 51 and the inductance unit 61, and thereby indirectly also to control the size of the gap G1 between the flow control unit 40 and the rotor 50, based on the electromagnetic forces affecting between the bridging element 51 and the inductance unit when the power generating unit 30 is operating.

Additionally, or alternatively, the size of the gap G1 between the flow control unit 40 and the rotor 50 may take place by controlling the fluid rate and/or pressure intended to cause the rotor 50 to float. FIG. 1, for example, discloses schematically control means 26, 27 intended to control the fluid rates and/or pressures of the fluid flows causing the rotor to float and rotate.

The control of the size of the gap G2 between the bridging element 51 and the inductance unit 61, and thereby indirectly also the control of the size of the gap G1 between the flow control unit 40 and the rotor 50, or vice versa, and other possible controls applied in the generator, may take place by computer-aided means.

The fluid flow F may be an air flow, a steam flow, an exhaust gas flow or liquid flow, or any combination thereof.

The fluid flow F may be a pressurized air flow, a pressurized steam flow, a pressurized exhaust gas flow or a pressurized liquid flow, or any combination thereof.

The fluid flow F may be a flow of fluid in a gaseous, supercritical or heterogeneous fluid phase.

The air flow may be caused by a wind, whereby the generator 10 may be used as a wind turbine.

The air flow may also be a pressurized air flow in an industrial pressurized air system, for example.

The fluid flow F may be a steam flow that may originate from an engine or a system generating the steam flow.

The fluid flow F may be exhaust gas flow that may originate from an engine or a system generating the exhaust gas flow.

In the case of the fluid flow F does not have a high enough pressure for properly operating the power generating unit 30, a pressure increasing arrangement, comprising for example a number of adjustable jet nozzles, for increasing the pressure of the fluid flow F, may be arranged at the inlet of the flow channel unit 40.

A typical pressure of the fluid flow F to be supplied into the generator may be, for example, between 8 to 15 bars.

A nominal power of the generator 10 disclosed may vary for example, but not limited to, between 1 kW and 1 MW.

A typical rotation speed of the rotor may be, for example, 3000 rpm-50000 rpm (revolutions per minute) equaling to a rotation frequency 88 from 50/s or 50 Hz (Hertz) to approximately 833/s or 833 Hz.

In the embodiment disclosed above, the same fluid flow in same fluid phase is used both to cause the rotor to float as well as to rotate the rotor. However, the fluid flows causing the rotor to float and to rotate may be different fluid flows.

The fluid flows causing the rotor to float and to rotate may be in same fluid phase or in different fluid phases or same fluid flow in different fluid phases.

Furthermore, the directions of supply of the fluid flows causing the rotor to float and to rotate the rotor may be same, different or opposing.

Furthermore, as disclosed above, the rotor does not have to comprise a specific rotor shaft or physical rotation axle to remain stationary in the radial direction, and still be able rotate in the circumferential direction.

However, the rotor may also comprise a shaft to keep it fixedly aligned relative to the rotation axis X.

The shaft which may also be hollow in order to provide at least one flow channel.

The shaft may also provide a central rotation axis for the rotor in the power generating unit.

Furthermore, in the embodiment disclosed above, the generator comprises only one rotor and one flow channel unit. However, the number of rotors may be more than one.

The number of flow channel units may be more than one.

Additionally, the generator may comprise two or more rotors with at least two different sizes to provide an optimized size to set a proper nominal power of the generator.

Thus, the generator may thus comprise a rotor system comprising at least two rotors, the rotor system arranged as a single rotor as disclosed above.

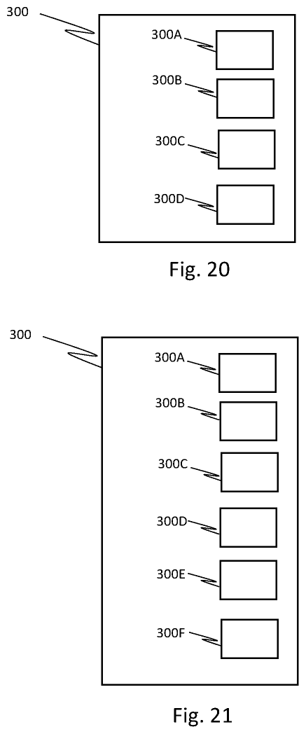

Referring next to FIG. 20, and for the structural details, to FIG. 1, as another aspect of the present invention, a method 300 for generating electricity with a generator 10 is disclosed. The generator 10 comprises at least one flow channel unit 40, at least one rotor 50 arranged to rotate, at least one bridging element 51, an inductance unit holder 60, the inductance unit holder 60 comprising at least one inductance unit 61, the inductance unit 61 comprising at least one inductance coil 61a, and a core 61c. The method 300 comprises steps of:
300A conveying, with at least one flow channel unit 40, a fluid flow to the rotor 50 for operating the rotor 50,
300B rotating the rotor 50 relative to the flow channel unit 40 in a floating bearing manner and in a rotation frequency 88,
300C rotating the at least one bridging element 51 about a rotation axis X of the rotor 50 in response to the rotation of the rotor 50,
300D inducing, with the at least one bridging element 51, an alternating and pulsed voltage to the at least one inductance coil 61a in response to the rotation of the at least one bridging element 51 relative to the inductance unit 61.

In an embodiment of the method 300, as shown in FIG. 21, the method also comprises steps of:
300E alternating, through the rotation of the at least one bridging element 51 about the rotation axis X, a magnetic circuit 90 between
   an open state 90o, in which the magnetic circuit 90o is formed of the inductance unit 61 and of at least one substance 61s which at least partially surrounds the inductance unit 61, and
   a closed state 90c, in which the magnetic circuit 90c is formed of the bridging element 51, of the inductance unit 61 and of the at least one substance 61s which at least partially surrounds the inductance unit 61, and
300F inducing, through the alternating step 300E, a voltage to the at least one inductance coil 61a of the at least one inductance unit 61.

In an embodiment of the method 300, the method is executed in a generator 10 according to the generator aspect and its embodiments as defined above.

All the method steps 300A-300F may be executed concurrently.

The invention has been described above with reference to the examples shown in the figures. However, the invention is in no way restricted to the above examples but may vary within the scope of the claims.

1.-23. (canceled)

24. A generator, wherein the generator comprises:
at least one rotor arranged to rotate,
at least one bridging element arranged to rotate about a rotation axis (X) of the rotor in response to the rotation of the rotor,
an inductance unit holder, the inductance unit holder comprising:
at least one inductance unit, the inductance unit comprising:
at least one inductance coil,
and a core, the at least one bridging element arranged to induce an alternating and pulsed voltage to the at least one inductance coil in response to the rotation of the bridging element relative to the inductance unit,
the generator comprising:
at least one flow channel unit arranged to convey a fluid flow to the rotor for operating the rotor, wherein the rotor is arranged to rotate relative to the flow channel unit in a floating bearing manner and in a rotation frequency.

25. The generator according to claim 24, wherein the at least one bridging element is provided to the rotor, and the inductance unit holder is arranged to be stationary in the generator.

26. The generator according to claim 24, wherein the rotor comprises an outer circumference, and at least two bridging elements are arranged at the outer circumference of the rotor, the at least two bridging elements being separated with a first angular interval, and at least two inductance units are arranged in the inductance unit holder, the at least two inductance units being separated with a second angular interval.

27. The generator according to claim 24, wherein:
the rotor comprises a first end plate, the first end plate forming a first end of the rotor, and at least two bridging elements are arranged at the first end plate of the rotor, the bridging elements being separated with a first angular interval, and at least two inductance units are arranged in the inductance unit holder, the at least two inductance units being separated with a second angular interval; or
the rotor comprises a second end plate, the second end plate forming a second end of the rotor, and at least two bridging elements are arranged at the second end plate of the rotor, the bridging elements being separated with a first angular interval, and at least two inductance units are arranged in the inductance unit holder, the at least two inductance units being separated with a second angular interval.

28. The generator according to claim 24, wherein
each of the bridging elements has a bridging angular length,
each of the bridging elements is separated from the adjacent bridging element by a bridging angular separation,
each of the inductance units has an inductance unit angular length,
each of the inductance units is separated from the adjacent inductance unit by an inductance unit angular separation,
such that the bridging angular length is between 70% and 130% of the bridging angular separation,
the inductance unit angular separation is between 70% and 130% of the bridging angular separation, and
the bridging angular length is between 70% and 130% of the inductance unit angular length, whereby the alternating and pulsed voltages of each of the inductance coils merge to alternating and continuous voltages for each of the inductance coils of the inductance units, the alternating and continuous voltages having a frequency which is a number of bridging elements multiplied by the rotation frequency of the rotor.

29. The generator according to claim 24, wherein the rotor comprises a predetermined number (N_{B}) of bridging elements and the inductance unit holder comprises a predetermined number (N_{I}) of inductance units such that the predetermined number of bridging elements (N_{B}) is equal to the predetermined number (N_{I}) of inductance units, whereby the alternating and pulsed voltages of all the inductance coils of the inductance units have a same phase and have a pulse frequency, the pulse frequency being the predetermined number of bridging elements (N_{B}) multiplied by the rotation frequency of the rotor.

30. The generator according to claim 24, wherein the rotor comprises a predetermined number (N_{B}) of bridging elements and the inductance unit holder comprises a predetermined number (N_{I}) of inductance units such that the predetermined number of bridging elements (N_{B}) is not equal to the predetermined number (N_{I}) of inductance units, whereby the alternating and pulsed voltages of the inductance coils of each of the inductance units have at least two different phases, and have a same pulse frequency, the pulse frequency being the predetermined number of bridging elements (N_{B}) multiplied by the rotation frequency of the rotor.

31. The generator according to claim 24, wherein the rotor comprises a predetermined number (N_{B}) of bridging elements and the inductance unit holder comprises a predetermined number (N_{I}) of inductance units such that:
the predetermined number of bridging elements (N_{B}) is one more than the predetermined number (N_{I}) of inductance units, whereby the alternating and pulsed voltages of the inductance coils of each of the inductance units have a number of phases which equals to the predetermined number (N_{I}) of inductance units, and a pulse frequency which is the predetermined number of bridging elements (N_{B}) multiplied by the rotation frequency of the rotor; or
the predetermined number of bridging elements (N_{B}) is one less than the predetermined number (N_{I}) of inductance units, whereby the alternating and pulsed voltages of the inductance coils of each of the inductance units have a number of phases which equals to the predetermined number (N_{I}) of inductance units, and a pulse frequency which is the predetermined number of bridging elements (N_{B}) multiplied by the rotation frequency of the rotor.

32. The generator according to claim 24, wherein
as the at least one bridging element is arranged to rotate about a rotation axis (X), the at least one bridging element is arranged into a rotational movement that causes the at least one bridging element to arrange a magnetic circuit to alternate between
an open state, in which the magnetic circuit is formed of the inductance unit and of at least one substance which at least partially surrounds the inductance unit, and
a closed state, in which the magnetic circuit is formed of the bridging element, of the inductance unit, and of the at least one substance which at least partially surrounds the inductance unit,
such that a voltage is induced to the inductance coil of the inductance unit.

33. The generator according to claim 32, wherein the at least one substance which at least partially surrounds the inductance unit comprises the fluid of the fluid flow operating the rotor.

34. The generator according to claim 24, wherein the core of the inductance unit comprises ferromagnetic material, and the core of the inductance unit:
comprises a permanent magnet portion; or
comprises an electromagnet; or
is a permanent magnet.

35. The generator according to claim 24, wherein the bridging element:
comprises a permanent magnet; or
comprises an electromagnet; or
comprises ferromagnetic material.

36. The generator according to claim 32, wherein the open state, the bridging element is unmagnetized.

37. The generator according to claim 24, wherein the generator comprises at least one rectifier, the at least one rectifier comprising alternating voltage input nodes and rectified voltage output nodes, the inductance unit comprising:
one inductance coil connected to the alternating voltage input nodes of the rectifier; or
a first inductance coil and a second inductance coil, the first inductance coil connected to the alternating voltage input nodes of a first rectifier, and the second inductance coil connected to the alternating voltage input nodes of a second rectifier; or
a first inductance coil and a second inductance coil arranged in a series connection, the series connection connected to the alternating voltage input nodes of the at least one rectifier; or
a first inductance coil and a second inductance coil arranged in a parallel connection, the parallel connection connected to the alternating voltage input nodes of the at least one rectifier.

38. The generator according to claim 37, wherein the generator comprises:
at least one electrical energy storage unit connected to the rectified voltage output nodes of the at least one rectifier; or
at least one electrical energy storage unit connected to the rectified voltage output nodes of the at least one rectifier, and at least one inverter arranged to convert rectified voltage of the at least one electrical energy storage unit to an alternating output voltage.

39. The generator according to claim 24, wherein
the flow channel unit and the rotor have a common axial direction (X), and in that
the flow channel unit and the rotor are arranged in the axial direction (X) substantially successively to each other.

40. The generator according to claim 24, wherein the rotor is arranged to rest on the flow channel unit when the generator is not in use, and to float relative to the flow channel unit when the generator is in operation.

41. The generator according to claim 24, wherein
the flow channel unit comprises at least one channel for conveying at least one fluid flow between the flow channel unit and the rotor to create a pressure effect between the flow channel unit and the rotor to push, in the axial direction (X) of the flow channel unit and the rotor, the rotor away from the flow channel unit such that a gap (G1) is arranged between the flow channel unit and the rotor for allowing the rotor to rotate relative to the flow channel unit substantially friction-free,
and in that the flow channel unit comprises at least one channel for conveying at least one fluid flow to the rotor for rotating the rotor.

42. The generator according to claim 24, wherein the rotor is arranged to at least partly surround the flow channel unit.

43. The generator according to claim 24, wherein the at least one rotor comprises a number of rotor flow channels extending in at least partly radial direction (R) of the rotor, the fluid flow flowing through the rotor flow channels for rotating the rotor.

44. A method for generating electricity with a generator, wherein the generator comprises:
at least one flow channel unit,
at least one rotor arranged to rotate,
at least one bridging element,
an inductance unit holder, the inductance unit holder comprising at least one inductance unit, the inductance unit comprising:
at least one inductance coil, and
a core, the method comprising steps of:
conveying, with at least one flow channel unit, a fluid flow to the rotor for operating the rotor,
rotating the rotor relative to the flow channel unit in a floating bearing manner and in a rotation frequency,
rotating the at least one bridging element about a rotation axis (X) of the rotor in response to the rotation of the rotor,
inducing, with the at least one bridging element, an alternating and pulsed voltage to the at least one inductance coil in response to the rotation of the at least one bridging element relative to the inductance unit.

45. The method according to claim 44, wherein the method comprises steps of:
alternating, through the rotation of the at least one bridging element about the rotation axis (X), a magnetic circuit between
an open state, in which the magnetic circuit is formed of the inductance unit and of at least one substance which at least partially surrounds the inductance unit, and
a closed state, in which the magnetic circuit is formed of the bridging element, of the inductance unit and of the at least one substance which at least partially surrounds the inductance unit, and
inducing, through the alternating step, a voltage to the at least one inductance coil of the at least one inductance unit.

46. The method for generating electricity with a generator, wherein the generator comprises:
at least one flow channel unit,
at least one rotor arranged to rotate,
at least one bridging element,
an inductance unit holder, the inductance unit holder comprising at least one inductance unit, the inductance unit comprising:
at least one inductance coil, and
a core, the method comprising steps of:
conveying, with at least one flow channel unit, a fluid flow to the rotor for operating the rotor,
rotating the rotor relative to the flow channel unit in a floating bearing manner and in a rotation frequency,
rotating the at least one bridging element about a rotation axis (X) of the rotor in response to the rotation of the rotor,
inducing, with the at least one bridging element, an alternating and pulsed voltage to the at least one inductance coil in response to the rotation of the at least one bridging element relative to the inductance unit, wherein the method is executed in a generator according to claim 24.
